(19) United States
(12) Patent Application Publication
(10) Pub. No.: US 2026/0342873 A1
(43) Pub. Date: Oct. 29, 2026

(54) PERSISTENT SESSION LOAD BALANCING AND VIRTUAL MACHINE DEALLOCATION

(71) Applicant: MICROSOFT TECHNOLOGY LICENSING, LLC, Redmond, WA (US)

(72) Inventors: Amit SHARMA, Bengaluru (IN); Shubham SINGH, Bengaluru (IN); Divyansh Kumar SINGH, Bengaluru (IN)

(21) Appl. No.: 19/192,282

(22) Filed: Apr. 28, 2025

(51) Int. Cl. H04L 67/1027; G06F 9/455; H04L 67/63

(52) U.S. Cl. CPC H04L 67/1027; G06F 9/45558; H04L 67/63; G06F 2009/45595

(57) ABSTRACT

Techniques are disclosed for dynamically distributing received requests for persistent sessions to virtual machines, and for selectively deallocating the virtual machines. A machine readiness status of a first virtual machine is determined. Received persistent session requests are routed to the first virtual machine when the determined machine readiness status has a first value. When the determined machine readiness status has a second value, subsequently received persistent session requests are routed to a second virtual machine, and no additional received persistent session requests are routed to the first virtual machine. The first virtual machine hosts persistent sessions corresponding to the received requests for persistent sessions routed to the first virtual machine. End times are determined for each hosted persistent session, and a maximum of the end times is determined. The first virtual machine is selectively deallocated based on the determined maximum end time.

### BACKGROUND

A data center is a facility that includes computer systems and various networking, storage, and other related components. For example, data centers may provide computing services to businesses and individuals as a remote computing service or provide “software as a service” (e.g., cloud computing). To facilitate efficient use of data center resources, virtualization technologies allow a physical computing device to host one or more virtual machines (VM) that appear, to a connected user, to operate as independent computer devices. The data center can create, maintain and delete virtual machines in a dynamic manner.

Remote desktop sessions are one type of computing service that data centers provide. Remote desktop sessions use communications protocols such as Remote Desktop Protocol (RDP) by Microsoft Corporation which allows users to remotely connect to other computers. Remote desktop sessions are a type of persistent session (sometimes called “sticky sessions”) in which requests from the same client are consistently routed to the same server. In this regard, a persistent session at a particular virtual machine or a node needs to persist over a longer period of time compared to general requests.

Data centers may receive multiple requests for persistent sessions from multiple users. To manage such persistent session requests, a load balancer may be used to distribute traffic amongst multiple resources, such as one or more virtual machines that host the persistent sessions. This disclosure describes technology for persistent session load balancing and virtual machine deallocation.

### SUMMARY

Service providers of virtualized computing resources may provide virtual machines to host persistent sessions. As a number of persistent session requests increase, the service provider may increase a number of virtual machines to host the persistent sessions, and a load balancer may distribute the persistent sessions to evenly balance the load across all of the virtual machines. As traffic decreases, however, it can be challenging to remove virtual machines that host persistent sessions. In particular, each persistent session may have a corresponding end time or “session timeout.” Unless all persistent session on a particular virtual machine have reached their corresponding session timeout, the virtual machine cannot be removed. A load balancer typically does not know which persistent sessions have reached their timeout, however, and thus continues to distribute persistent sessions across all virtual machines, thereby making it very difficult to remove any of the virtual machines. This may result in very low utilization across the various virtual machines and inefficient use of virtualized computing resources.

Technology is described for dynamically distributing received requests for persistent sessions to multiple virtual machines, and for doing so such that virtual machines may be deallocated once all persistent sessions hosted on a virtual machine have reached their maximum end time. In an example implementation, a load balancer uses a sliding window algorithm to route received persistent session requests to virtual machines based on “machine readiness” of the virtual machines. Machine readiness of a virtual machine may be determined by monitoring one or more machine readiness parameters, such as CPU utilization and/or number of persistent sessions hosted.

In embodiments, the load balancer routes received persistent session requests to a first virtual machine based on the machine readiness of the first virtual machine. For example (where machine readiness is based on CPU utilization), the load balancer routes received persistent session requests to the first virtual machine while the CPU utilization of the first virtual machine does not exceed a first threshold value (e.g., 60%). When the CPU utilization of the first virtual machine exceeds the first threshold value (e.g., 60%), the load balancer routes subsequently received persistent session request to a second virtual machine, and does not route additional received persistent session requests to the first virtual machine.

In embodiments, this process continues with each sequential virtual machine. For example, the load balancer routes received persistent session requests to the second virtual machine while the CPU utilization of the second virtual machine does not exceed the first threshold, and then routes subsequently received persistent session requests a third virtual machine when the CPU utilization of the second virtual machine exceeds the first threshold. Once the CPU utilization of the second virtual machine exceeds the first threshold, the load balancer does not route additional requests to the second virtual machine.

In contrast to a conventional load balancing technique in which the load is evenly distributed amongst multiple virtual machines, in the disclosed technology the load is distributed to virtual machines one at a time, continuing until each virtual machine is no longer “ready” to receive persistent session requests before moving on to the next sequential virtual machine. After a virtual machine is no longer ready to receive persistent session requests, no additional received persistent session requests are routed to the virtual machine.

In addition, technology is described for selectively deallocating virtual machines once all persistent sessions hosted on a virtual machine have reached their maximum end time, or session timeout. In an embodiment, as the load balancer routes each persistent session request to a virtual machine, the load balancer determines a start time (e.g., using a time stamp) and end time for the persistent session, and determines a persistent session maximum end time for the virtual machine. That is, if a virtual machine hosts multiple persistent sessions, each having a different end time, the load balancer determines a maximum end time for all of the persistent sessions hosted on the virtual machine.

In embodiments, the load balancer selectively deallocates each virtual machine at the persistent session maximum end time for the virtual machine. In addition, if users cancel persistent sessions prior to the sessions'end times, the load balancer optionally also may determine a persistent session maximum cancellation time for the persistent sessions hosted on the virtual machine. In embodiments, the load balancer deallocates the virtual machine at the later of the persistent session maximum end time, and the persistent session maximum cancellation time for the virtual machine.

The described techniques can allow for maintaining efficient use of computing resources such as processor cycles, memory, network bandwidth, and power, while reducing potential loss of data and services and downtime, resulting in impact to end users.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating a data center for providing virtualized resources in accordance with the present disclosure.

FIG. 2 is another diagram illustrating a data center for providing virtualized resources in accordance with the present disclosure.

FIG. 3A is still another diagram illustrating a data center for providing virtualized resources in accordance with the present disclosure.

FIG. 3B is yet another diagram illustrating a data center for providing virtualized resources in accordance with the present disclosure.

FIG. 4A is a flowchart depicting an example procedure for dynamically distributing persistent session requests to virtual machines and deallocating the virtual machines in accordance with the present disclosure.

FIG. 4B is a flowchart depicting an example procedure for dynamically distributing persistent session requests to virtual machines in accordance with the present disclosure.

FIG. 4C is a flowchart depicting an example procedure for determining deallocation times for virtual machines in accordance with the present disclosure.

FIGS. 5A-5N are diagrams illustrating an example computing environment for providing virtualized resources in accordance with the present disclosure.

FIGS. 6A-6N are timing diagrams corresponding to the example computing environment of FIGS. 5A-5N.

FIG. 7 is a flowchart depicting an example procedure for dynamically distributing persistent session requests to virtual machines and deallocating the virtual machines in accordance with the present disclosure.

FIG. 8 is an example computing device in accordance with the present disclosure.

### DETAILED DESCRIPTION

Distributing persistent sessions evenly across multiple virtual machines may result in inefficient use of virtualized computing resources. In particular, a virtual machine hosting multiple persistent sessions cannot be deallocated until all persistent sessions have reached their timeout. But if a load balancer continues to evenly distribute persistent sessions across multiple virtual machines, the number of virtual machines cannot be reduced, even if each virtual machine is hosting only a single persistent session.

Technology is described for dynamically distributing received requests for persistent sessions to multiple virtual machines, and selectively deallocating virtual machines once all persistent sessions hosted on a virtual machine have reached their maximum end time.

In an embodiment, a load balancer routes received persistent session requests to virtual machines based on machine readiness (e.g., CPU utilization, number of hosted persistent sessions, or some other parameter) of the virtual machines. In embodiments, a virtual machine may have a machine readiness status having either of a first machine readiness value or a second machine readiness value. In an embodiment, a first machine readiness value may be “ready,” “1,” or some other value. In an embodiment, a second machine readiness value may be “not ready,” “0,” or some other value.

In an embodiment, the load balancer routes received persistent session requests to virtual machines one virtual machine at a time, routing received persistent session requests to the same virtual machine while the virtual machine has a machine readiness status having the first machine readiness value (e.g., ready). When the machine readiness status of the virtual machine changes from the first machine readiness value to the second machine readiness value (e.g., not ready), no additional received persistent session requests are routed to the virtual machine, and subsequently received persistent session requests are routed to a next sequential virtual machine. In embodiments, this process continues with each successive virtual machine.

By performing load balancing in this manner, a finite number of persistent sessions are hosted on each virtual machine, such that the virtual machine can ultimately be deallocated once all of the persistent sessions on the virtual machine have timed out. This is in contrast to techniques in which persistent session requests continue being routed to virtual machines, which makes deallocating the virtual machines difficult to do.

Instead of attempting to deallocate virtual machines which continue to receive persistent session requests, in addition to the above hosting of a finite number of persistent sessions, technology is described for selectively deallocating virtual machines once all persistent sessions hosted on a virtual machine have reached their maximum end time, or session timeout. In an embodiment, the load balancer determines an end time for each persistent session hosted on a virtual machine, and determines a maximum end time for all of the persistent sessions hosted on the virtual machine. In embodiments, the load balancer selectively deallocates each virtual machine at the persistent session maximum end time for the virtual machine.

In an embodiment, the load balancer optionally also determines a persistent session maximum cancellation time (when a user terminates a persistent session before the session timeout) for the persistent sessions hosted on the virtual machine. In embodiments, the load balancer deallocates the virtual machine at the later of: the persistent session maximum end time and the persistent session maximum cancellation time for the virtual machine.

Referring to the appended drawings, in which like numerals represent like elements throughout the several figures, aspects of various technologies for persistent session load balancing and virtual machine deallocation will be described. In the following detailed description, references are made to the accompanying drawings that form a part hereof, and which are shown by way of illustration specific configurations or examples.

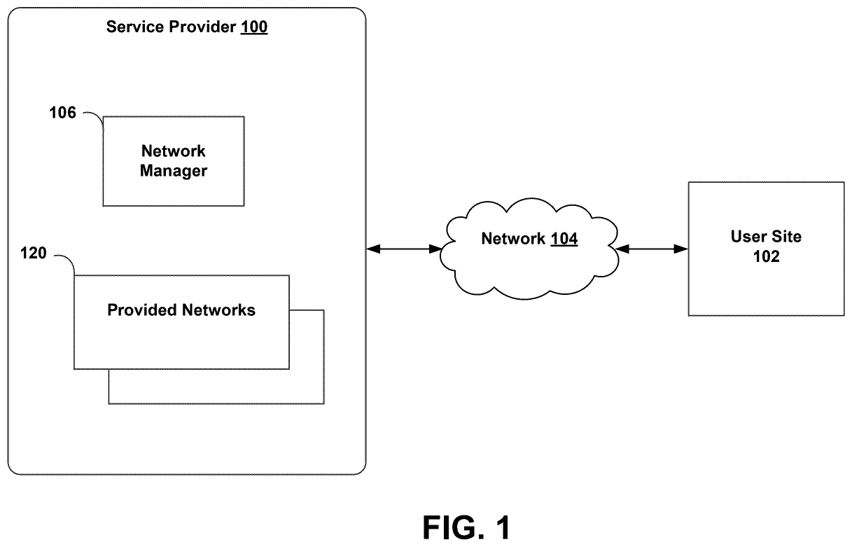

FIG. 1 illustrates an example computing environment in which the embodiments described herein may be implemented. FIG. 1 illustrates a service provider 100 that is configured to provide computing resources to users at user site 102. User site 102 may have user computers that access services provided by service provider 100 via a network 104.

Network 104 may be a publicly accessible network of linked networks and may be operated by various entities, such as the Internet. In other embodiments, network 104 may be a private network, such as a dedicated network that is wholly or partially inaccessible to the public. Network 104 may provide access to computers and other devices at user site 102.

Service provider 100 may include various types of resources, such as computing resources, data storage resources, networking resources, and the like. Computing resources may include servers, routers, and other devices that may provide remotely accessible computing and network resources using, for example, virtual machines that may be configured to execute applications, including Web servers, application servers, media servers, database servers, and the like.

Data storage resources may include file storage devices, block storage devices, and the like. Networking resources may include virtual networking, software load balancing, and the like. Service provider 100 also may execute functions that manage and control allocation of network resources, such as a network manager 106.

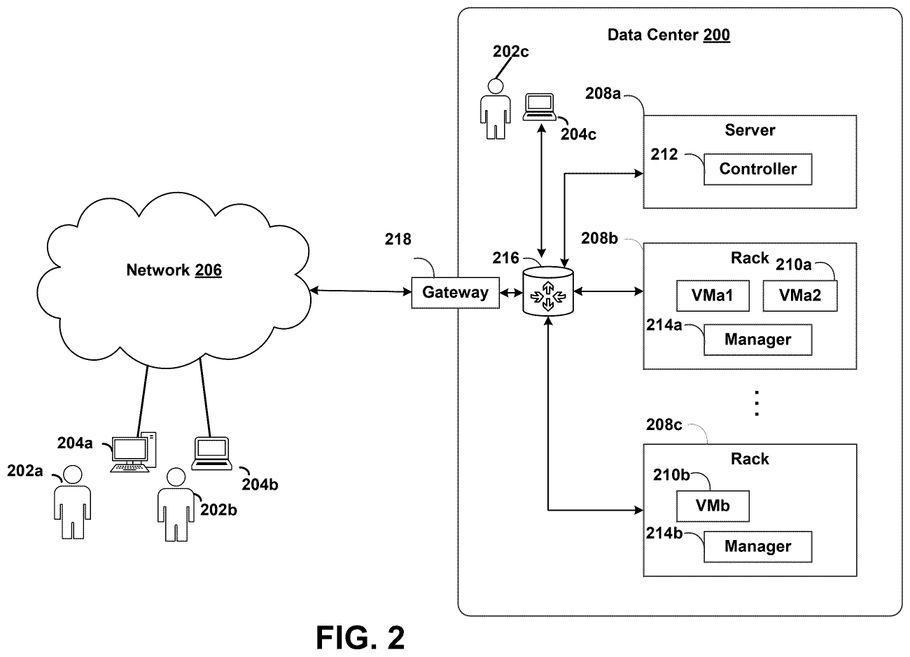

FIG. 2 illustrates another example computing environment in which the embodiments described herein may be implemented. FIG. 2 illustrates a data center 200 configured to provide various resources to users 202a, 202b, or 202c (which may be referred herein singularly as “user 202” or in the plural as “users 202”) via user computers 204a, 204b, and 204c (which may be referred herein singularly as “computer 204” or in the plural as “computers 204”) via a network 206.

In embodiments, resources provided by data center 200 include one or more of various types of resources, such as computing resources, data storage resources, data communication resources, and the like. In embodiments, each type of resource may be a general-purpose resource or may be available in a number of specific configurations.

For example, in embodiments computing resources are available as virtual machines that may be configured to execute applications, including Web servers, application servers, media servers, database servers, and the like. In embodiments, data storage resources include one or more of file storage devices, block storage devices, and the like. In embodiments, each type or configuration of resource may be available in different configurations, such as the number of processors, and size of memory and/or storage capacity.

In embodiments, the computing resources may be offered to clients in units referred to as instances, such as virtual computing instances or storage instances. As used herein, a virtual computing instance may be referred to as a virtual machine and may, for example, include one or more servers with a specified computational capacity (which may be specified by indicating the type and number of CPUs, the main memory size and so on) and a specified software stack (e.g., a particular version of an operating system, which may in turn run on top of a hypervisor).

Data center 200 may include servers 208a, 208b, and 208c (which may be referred to herein singularly as “server 208” or in the plural as “servers 208”) that provide computing resources available as virtual machines 210a and 210b (which may be referred to herein singularly as “virtual machine 210” or in the plural as “virtual machines 210”). Virtual machines 210 may be configured to execute applications such as Web servers, application servers, media servers, database servers, and the like.

Servers 208 also may provide data storage resources (not shown on FIG. 2) and may include file storage devices, block storage devices, and the like. Servers 208 also may execute functions that manage and control allocation of resources in data center 200, such as a controller 212. Controller 212 may be a fabric controller or another type of program configured to manage the allocation of virtual machines on servers 208.

Network 206 may be a publicly accessible network of linked networks and may be operated by various entities, such as the Internet. In other embodiments, network 206 may be a private network, such as a corporate network that is wholly or partially inaccessible to the public.

Network 206 may provide access to computers 204, which may be utilized by users 202. Each of computers 204 may be a server, a desktop or laptop personal computer, a tablet computer, a smartphone, a set-top box, or any other computing device capable of accessing data center 200.

Computer 204a and 204b may connect directly to network 206 (e.g., via a cable modem), whereas computer 204c may be internal to data center 200 and may connect directly to the resources in data center 200 via internal networks. Although only three computers 204a, 204b, and 204c are depicted, more or fewer than three computers 204 may be coupled to data center 200.

Computers 204 also may be utilized to configure aspects of the computing resources provided by data center 200. For example, data center 200 may provide a Web interface through which aspects of its operation may be configured through the use of a Web browser application program executing on computer 204. Alternatively, a stand-alone application program executing on computer 204 may be used to access an application programming interface (API) exposed by data center 200 for performing configuration operations.

Servers 208 may be configured to provide the computing resources described above. One or more of servers 208 may be configured to execute a manager 214a or 214b (which may be referred herein singularly as “manager 214” or in the plural as “managers 214”) configured to execute the virtual machines. Managers 214 may be a virtual machine monitor, fabric controller, or other type of program configured to enable the execution of virtual machines 210 on servers 208, for example.

Although the embodiments disclosed above are discussed in the context of virtual machines, other types of implementations can be utilized with the concepts and technologies disclosed herein. For example, the embodiments disclosed herein also may be utilized with computing systems that do not utilize virtual machines.

In example data center 200, a router 216 may be utilized to interconnect servers 208a, 208b and 208c. Router 216 also may be connected to a gateway 218, which is connected to network 206. Router 216 may manage communications within networks in data center 200, for example, by forwarding packets or other data communications as appropriate based on characteristics of such communications (e.g., header information including source and/or destination addresses, protocol identifiers, etc.) and/or the characteristics of the private network (e.g., routes based on network topology, etc.).

The example network topology of FIG. 2 has been greatly simplified. Many more networks and networking devices may be utilized to interconnect the various computing systems, and various aspects of the computing systems and other devices of this example are illustrated without showing certain conventional details. Additional computing systems and other devices may be interconnected in other embodiments and may be interconnected in different ways. These network topologies and devices should be apparent to those skilled in the art.

Also, data center 200 of FIG. 2 is merely illustrative, and other implementations may be utilized. Additionally, the functionality disclosed herein might be implemented in software, hardware or a combination of software and hardware. Other implementations should be apparent to those skilled in the art.

In addition, a server, a gateway, or other computing device may include any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities.

Moreover, the functionality provided by the illustrated modules may in some embodiments be combined in fewer modules or distributed in additional modules. Similarly, in some embodiments the functionality of some of the illustrated modules may not be provided and/or other additional functionality may be available.

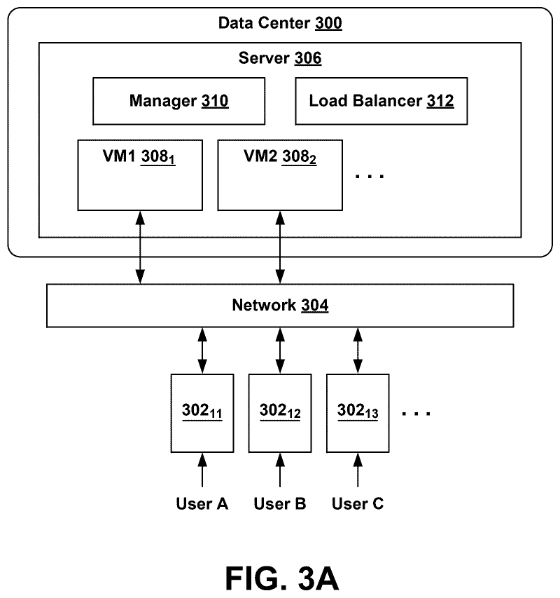

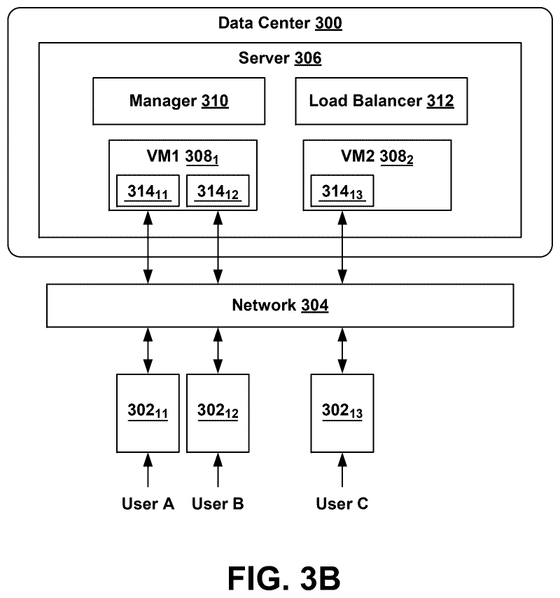

FIG. 3A illustrates another example computing environment in which the embodiments described herein may be implemented. FIG. 3A illustrates a data center 300 configured to provide various resources to users (e.g., User A, User B, User C, . . . ) via user computers 302 (e.g., user computers 302₁₁, 302₁₂, 302₁₃, . . . , respectively) and a network 304.

In an embodiment, data center 300 includes a server 306 that provides computing resources to Users (e.g., User A, User B, User C, . . . ). In embodiments, the computing resources may be offered to clients in units referred to as instances, such as virtual computing instances or storage instances. As used herein, a virtual computing instance may be referred to as a virtual machine.

In the embodiment of FIG. 3A, server 306 provides computing resources available as virtual machines 308 (e.g., 308₁, 308₂, . . . ). Although a single server 306 is depicted in FIG. 3, in other embodiments, more than one server may be used to provide virtual machines 308. In embodiments, virtual machines 308 may be configured to execute applications such as Web servers, application servers, media servers, database servers, and the like. As described in more detail below in an embodiment virtual machines 308 are configured to host one or more persistent sessions, such as one or more remote desktop sessions.

User computers 302 may connect directly to network 304 (e.g., via a cable modem). Although only three user computers 302₁₁, 302₁₂, 302₁₃, . . . , are depicted, more or fewer than three user computers 302 may be coupled to data center 300. Each of user computers 302 may be a server, a desktop computer, a laptop computer, a tablet computer, a smartphone, a set-top box, or any other computing device capable of accessing data center 300.

Network 304 may be a publicly accessible network of linked networks and may be operated by various entities, such as the Internet. In other embodiments, network 304 may be a private network, such as a corporate network that is wholly or partially inaccessible to the public. Network 304 may provide user computers 302 with access to data center 300.

Server 306 may be configured to provide the computing resources described above. One or more of servers 306 may be configured to execute one or more managers 310 configured to execute virtual machines 308. Manager 310 may be a virtual machine monitor, fabric controller, or other type of program configured to initiate virtual machines 308 on server 306, for example.

In embodiments, server 306 may be configured to execute one or more load balancers 312 configured to distribute traffic (e.g., requests from Users of user computers 302) to virtual machines 308. In an embodiment, manager 310 is configured to initiate one or more virtual machines 308, and load balancer 312 is configured to distribute traffic to the virtual machines 308 initiated by manager 310.

In other embodiments, load balancer 312 may be configured to initiate (directly or indirectly) one or more virtual machines 308, and load balancer 312 may be configured to distribute traffic to the virtual machines 308 initiated by load balancer 312. For example, load balancer 312 may request that manager 310 initiate one or more virtual machines 308. In such an example, load balancer 312 indirectly initiates the one or more virtual machines 308.

Although the embodiments disclosed above are discussed in the context of virtual machines, other types of implementations can be utilized with the concepts and technologies disclosed herein. For example, the embodiments disclosed herein also may be utilized with computing systems that do not utilize virtual machines.

The example network topology of FIG. 3A has been greatly simplified. Many more networks and networking devices may be utilized to interconnect the various computing systems, and various aspects of the computing systems and other devices of this example are illustrated without showing certain conventional details. Additional computing systems and other devices may be interconnected in other embodiments and may be interconnected in different ways. These network topologies and devices should be apparent to those skilled in the art.

Also, data center 300 of FIG. 3A is illustrative, and other implementations may be utilized. Additionally, the functionality disclosed herein might be implemented in software, hardware or a combination of software and hardware. Other implementations should be apparent to those skilled in the art.

In addition, a server, a gateway, or other computing device may include any combination of hardware or software that can interact and perform the described types of functionality, including without limitation desktop or other computers, database servers, network storage devices and other network devices, personal digital assistants, tablets, smartphones, Internet appliances, television-based systems (e.g., using set top boxes and/or personal/digital video recorders), and various other consumer products that include appropriate communication capabilities.

Moreover, the functionality provided by the illustrated modules may in some embodiments be combined in fewer modules or distributed in additional modules. Similarly, in some embodiments the functionality of some of the illustrated modules may not be provided and/or other additional functionality may be available.

As described above, in an embodiment virtual machines 308 are configured to host one or more persistent sessions, such as one or more remote desktop sessions. For example, as depicted in FIG. 3B in response to persistent session requests from Users (e.g., User A, User B and User C), load balancer 312 distributes the persistent session requests to one or more virtual machines 308 initiated by manager 310.

For example, manager 310 may initiate (or “boot”) virtual machines 308₁ and 308₂ (also referred to herein as virtual machines VM1 and VM2, respectively), and load balancer 312 distributes persistent session requests from User A, User B and User C to virtual machines VM1 and VM2. In response to the persistent session requests, virtual machine VM1 hosts persistent sessions 314₁₁ and 314₁₂ for User A and User B, respectively, and virtual machine VM2 hosts persistent session 314₁₃ for User C.

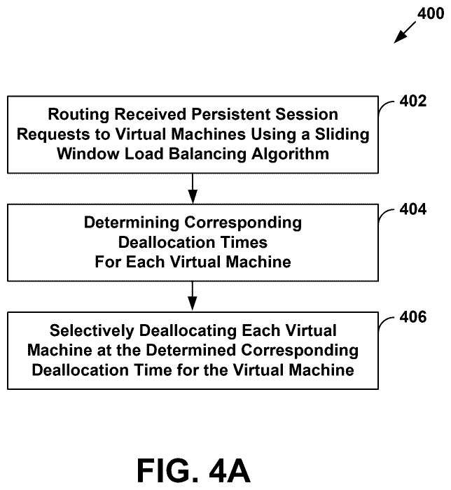

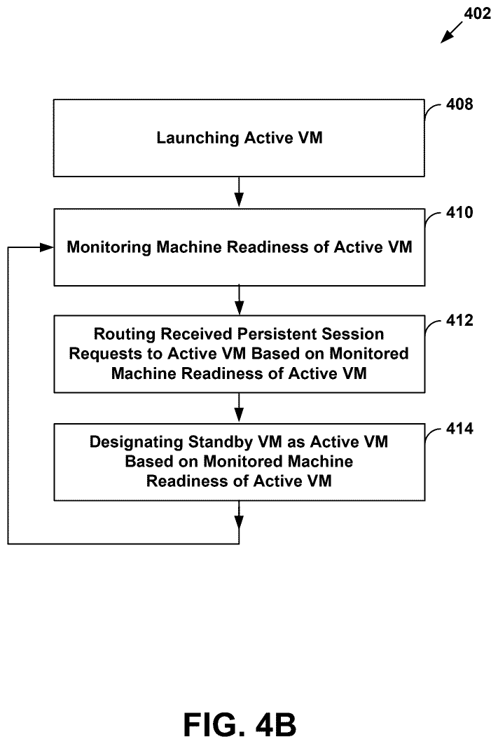

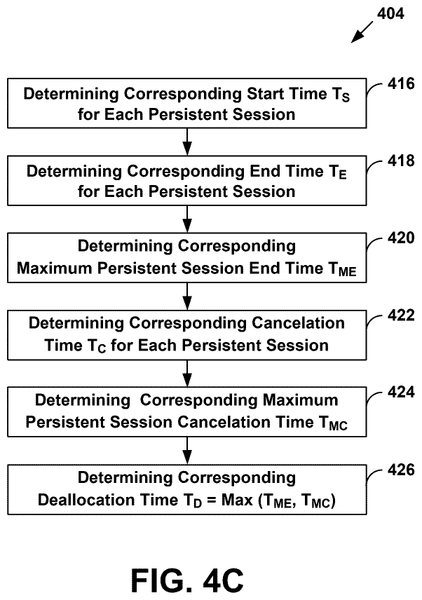

FIG. 4A illustrates an example operational procedure 400 for a load balancing algorithm to dynamically distribute persistent session requests, and to selectively deallocate virtual machines in accordance with the present disclosure. In embodiments, operational procedure 400 may be implemented in a system including one or more computing devices. For example, load balancer 312 of FIG. 3B may implement some or all of operational procedure 400.

The operations of the methods disclosed herein are not necessarily presented in any particular order and performing some or all of the operations in an alternative order is possible and is contemplated. The operations have been presented in the demonstrated order for ease of description and illustration. Operations may be added, omitted, performed together, and/or performed simultaneously, without departing from the scope of the appended claims.

The illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like.

Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, this routine can be performed on any computing system which may include a number of computers working in concert to perform the operations disclosed herein.

Thus, the logical operations described herein are implemented (1) as a sequence of computer implemented acts or program modules running on a computing system such as those described herein, and/or (2) as interconnected machine logic circuits or circuit modules within the computing system. The implementation is a matter of choice depending on performance and other requirements of the computing system. Accordingly, the logical operations may be implemented in software, in firmware, in special purpose digital logic, and any combination thereof.

Referring to FIG. 4A, operation 402 illustrates routing received persistent session requests from Users (e.g., User A, User B, User C, . . . ) to virtual machines (e.g., virtual machines 308 of FIG. 3B) using a sliding window load balancing algorithm. As described in more detail below, in an embodiment load balancer 312 uses a sliding window load balancing algorithm to dynamically distribute persistent session requests to virtual machines 308 in sequential order.

Operation 404 may follow operation 402. Operation 404 illustrates determining corresponding deallocation times for each virtual machine. As described in more detail below, in an embodiment load balancer 312 continually determines a corresponding deallocation time for each virtual machine as persistent session requests are routed to the virtual machines and as Users cancel persistent sessions on the virtual machines.

Operation 406 may follow operation 404. Operation 406 illustrates selectively deallocating each virtual machine at the determined corresponding deallocation time for the virtual machine. As described in more detail below, in an embodiment load balancer 312 selectively deallocates each virtual machine as each virtual machine reaches the corresponding deallocation time.

FIG. 4B illustrates a more detailed example of operation 402 of FIG. 4A for routing persistent session requests to virtual machines (e.g., virtual machines 308 of FIG. 3B) using a sliding window load balancing algorithm. In embodiments, operation 402 may be implemented in a system including one or more computing devices. For example, load balancer 312 of FIG. 3B may implement some or all of operation 402.

Operation 408 illustrates launching a first virtual machine 308 as an “active” virtual machine (“Active VM”) to receive persistent session requests. In an embodiment, no more than one virtual machine 308 can be designated as an active virtual machine at the same time.

Operation 410 may follow operation 408. Operation 410 illustrates monitoring a “machine readiness” of the Active VM. In an embodiment, machine readiness may be characterized in terms of machine health, such as CPU utilization or other user-configured parameter. In another embodiment, machine readiness may be characterized in terms of a number of persistent sessions hosted on a virtual machine 308. Other parameters may be used to characterize machine readiness, such as memory usage, and other parameters.

Operation 412 may follow operation 410. Operation 412 illustrates routing persistent session requests to the Active VM based on the monitored machine readiness of the Active VM. For example, persistent session requests may be routed to the Active VM until the machine readiness of the Active VM exceeds a first machine readiness threshold MR_{T1}.

For example, in embodiments in which machine readiness is characterized in terms of machine health, such as CPU utilization, first machine readiness threshold MR_{T1} may specify a first CPU utilization value (e.g., 60%). In such an embodiment, persistent session requests are routed to the Active VM until the CPU usage of the Active VM exceeds 60%.

In another example, in embodiments in which machine readiness is characterized in terms of number of persistent sessions hosted on the Active VM, first machine readiness threshold MR_{T1} may specify a first number of persistent sessions (e.g., 3). In such an embodiment, persistent session requests are routed to the Active VM until the number of persistent sessions hosted on the Active VM exceeds 3.

Operation 414 may follow operation 412. Operation 414 illustrates designating a second (“standby”) virtual machine (“Standby VM”) as the Active VM based on the monitored machine readiness of the Active VM. For example, the Standby VM may be designated as the Active VM when the machine readiness of the Active VM exceeds first machine readiness threshold MR_{T1}. As described above, in an embodiment no more than one virtual machine 308 can be designated as the Active VM at the same time. Thus, in an embodiment, when the machine readiness of the Active VM exceeds first machine readiness threshold MR_{T1}, the current Active VM is de-designated as the Active VM, and the Standby VM is designated as the Active VM.

Continuing the above examples, in embodiments in which first machine readiness threshold MR_{T1} specifies a first CPU utilization value (e.g., 60%), the Standby VM is designated as the Active VM when the CPU usage of the Active VM exceeds 60%. In embodiments in which first machine readiness threshold MR_{T1} specifies a first number of persistent sessions (e.g., 3), the Standby VM is designated as the Active VM when the number of persistent sessions hosted on the Active VM exceeds 3.

Operation 410 may follow operation 414, repeating operations 410-414 described above. As a result, after the previous Standby VM is designated as the current Active VM, the machine readiness of the current Active VM is monitored, and a new Standby VM is launched, and received persistent session requests are routed to current Active VM based on the monitored machine readiness of the current Active VM.

In this regard, load balancer 312 loads up each Active VM with persistent sessions until the Active VM exceeds first machine readiness threshold MR_{T1}, and then moves on to the next sequential virtual machine as the next Active VM. Without wanting to be bound by any particular theory, it is believed that the example sliding window load balancing technique described above may provide maximum utilization of each virtual machine 308. In embodiments, if the current Active VM is unable to process a received persistent session request, then load balancer 312 may route the persistent session request to a fallback/backup virtual machine 308 (not depicted in FIG. 3B).

In example operation 402 of FIG. 4B, a Standby VM is available to receive persistent session requests when the machine readiness of the Active VM exceeds first machine readiness threshold MR_{T1}. In an embodiment, load balancer 312 may launch a virtual machine 308 to be the Standby VM when load balancer 312 first begins routing persistent session requests the Active VM. In that regard, the Standby VM is available as soon as the Active VM starts to receive persistent session requests.

In another embodiment, load balancer 312 may launch a virtual machine 308 to be the Standby VM based on the monitored machine readiness of the Active VM. For example, a Standby VM may be launched when the machine readiness of the Active VM exceeds a second machine readiness threshold MR_{T2}.

For example, in embodiments in which machine readiness is characterized in terms of machine health, such as CPU utilization, second machine readiness threshold MR_{T2} may specify a second CPU utilization value (e.g., 50%). In such an embodiment, load balancer 312 launches a Standby VM when the CPU usage of the Active VM exceeds second machine readiness threshold MR_{T2} (50%).

In another example, in embodiments in which machine readiness is characterized in terms of number of persistent sessions hosted on the Active VM, second machine readiness threshold MR_{T2} may specify a second number of persistent sessions (e.g., 1). In such an embodiment, a Standby VM is launched when the number of persistent sessions hosted on the Active VM exceeds 1.

FIG. 4C illustrates an example operation 404 of FIG. 4A for determining a corresponding maximum persistent session end time for each virtual machine. In embodiments, operation 404 may be implemented in a system including one or more computing devices. For example, load balancer 312 of FIG. 3B may implement some or all of operation 404. In embodiments, the example operations depicted in FIG. 4C and described below may be performed for each virtual machine 308. For simplicity, the example operations will be described with respect to a single virtual machine 308.

Operation 416 illustrates determining a corresponding start time T_{S} for each persistent session on the virtual machine 308. In an embodiment, as each persistent session is routed to a virtual machine 308, load balancer 312 determines a corresponding persistent session start time (e.g., a first time stamp) T_{S} for the persistent session.

Operation 418 may follow operation 416. Operation 418 illustrates determining a corresponding persistent session end time T_{E} for each persistent session on the virtual machine 308. For example, when a User requests a persistent session, the User may specify a desired persistent session duration T_{L} (e.g., 1 hour, 2 hours, 8 hours, etc.). In such an embodiment, load balancer 312 determines a corresponding persistent session end time T_{E} for the persistent session as:

T_{E}=T_{S}+T_{L}

Alternatively, if the User does not specify a desired persistent session duration, data center 300 (or some other component of data center 300) may specify a default persistent session duration T_{ML} (e.g., 12 hours, 24 hours, etc.). In such an embodiment, load balancer 312 determines a corresponding persistent session end time T_{E} for the persistent session as:

T_{E}=T_{S}+T_{ML}

Operation 420 may follow operation 418. Operation 420 illustrates determining a corresponding maximum persistent session end time T_{ME} for the virtual machine 308. For example, if a virtual machine 308 hosts n persistent sessions having corresponding persistent session end times T_{E1}, T_{E2},. T_{En}, load balancer 312 may determine corresponding maximum persistent session end time T_{ME} for the virtual machine 308 as:

T_{ME}=MAX(T_{E1}, T_{E2}, . . . , T_{En})

Operation 422 may follow operation 420. Operation 422 illustrates determining a corresponding persistent session cancellation time T_{C} for each persistent session on the virtual machine 308. In some instances a User may terminate their persistent session before the corresponding persistent session end time T_{E} for the persistent session.

For example, a User may request a persistent session with a desired persistent session duration T_{L}=4 hours, but may terminate (or “cancel”) the session after 2 hours. In such instances, load balancer 312 determines a corresponding persistent session cancellation time T_{C} (e.g., a second time stamp) for the persistent session. In embodiments, if a User does not terminate their persistent session before the corresponding persistent session end time T_{E} for the persistent session, the persistent session does not have a corresponding persistent session cancellation time T_{C}.

Operation 424 may follow operation 422. Operation 424 illustrates determining a corresponding maximum persistent session cancellation time T_{MC} for the virtual machine 308. For example, if a virtual machine 308 host n persistent sessions having corresponding persistent session end times T_{C1}, T_{C2}, . . . , T_{Cn}, load balancer 312 may determine corresponding maximum persistent session cancellation time T_{MC} for the virtual machine 308 as:

T_{MC}=MAX(T_{C1}, T_{C2}, . . . , T_{Cn})

Operation 426 may follow operation 424. Operation 426 illustrates determining a corresponding deallocation time T_{D} for the virtual machine 308, which is the greater of the corresponding maximum persistent session end time T_{ME}, and the corresponding maximum persistent session cancellation time T_{MC} for the virtual machine 308:

T_{D}=MAX(T_{ME}, T_{MC})

Thus, in an embodiment load balancer 312 may determine a corresponding deallocation time T_{D} for the virtual machine 308, and may deallocate the virtual machine 308 at the determined corresponding deallocation time T_{D}.

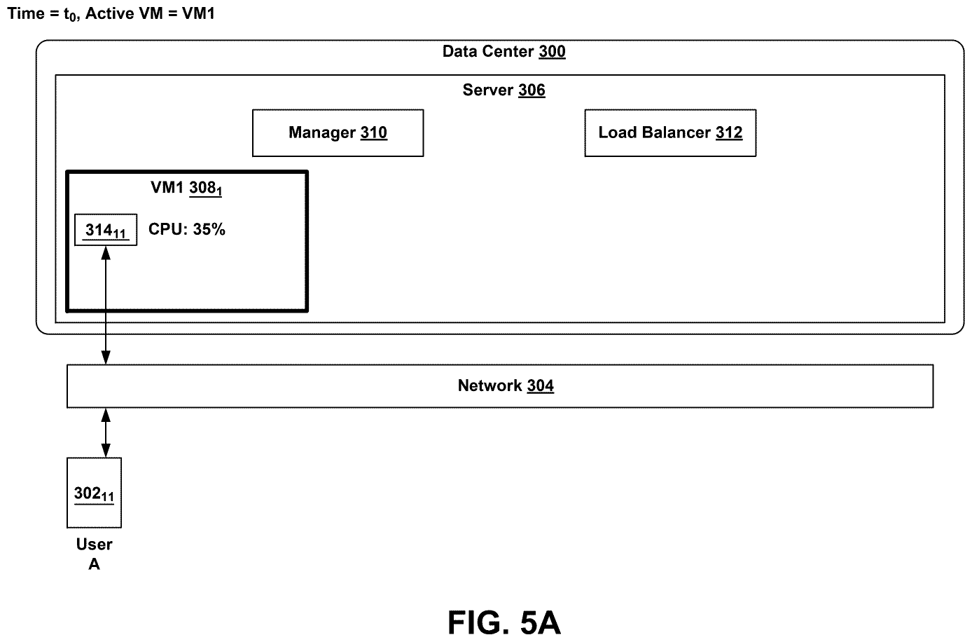

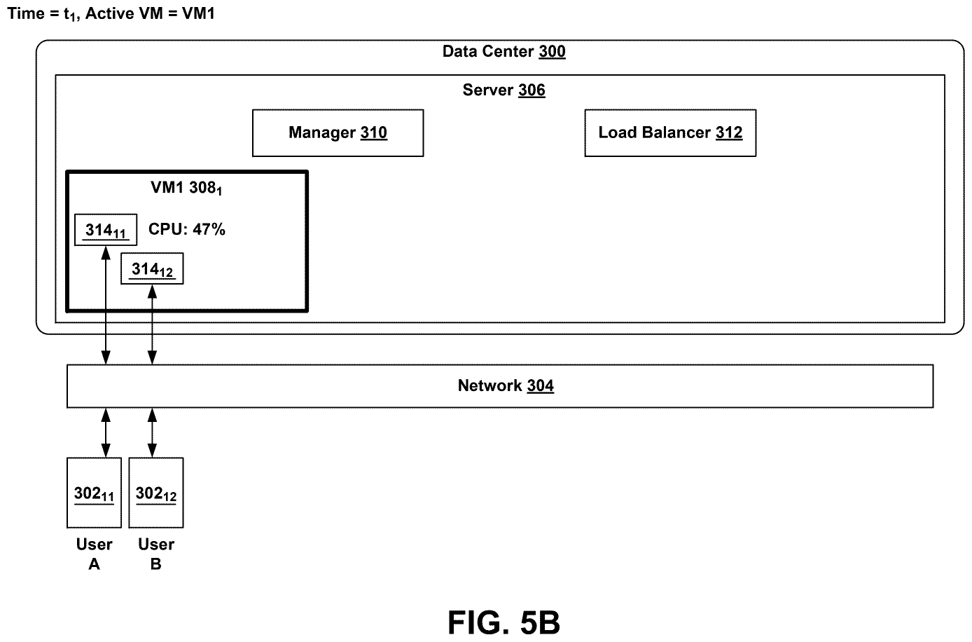

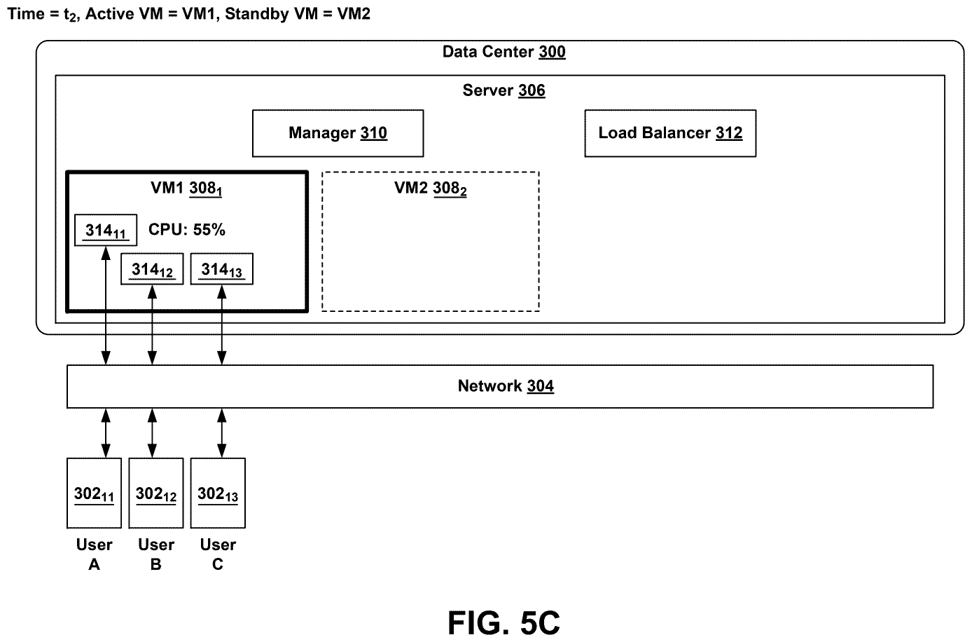

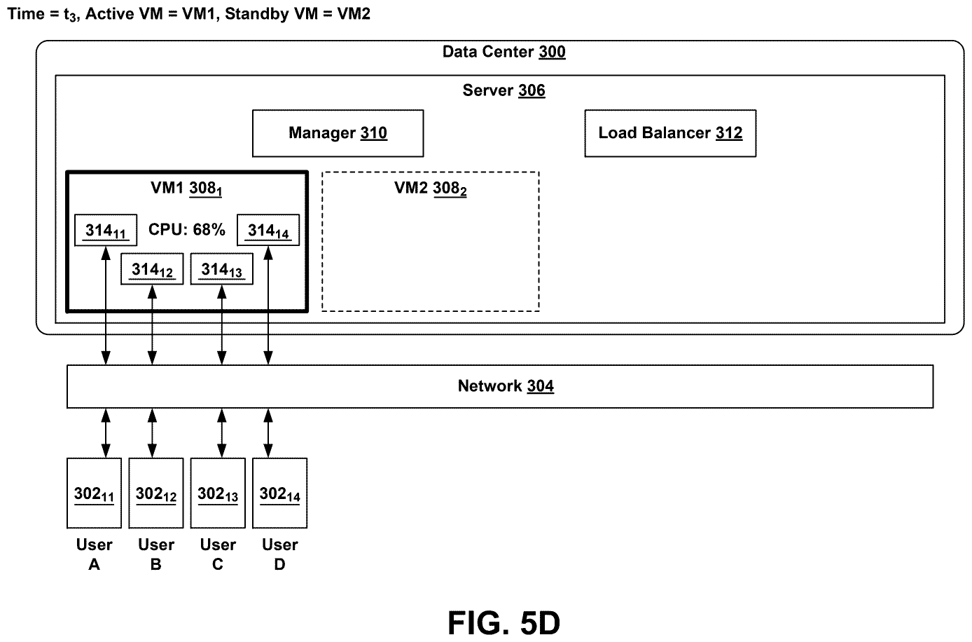

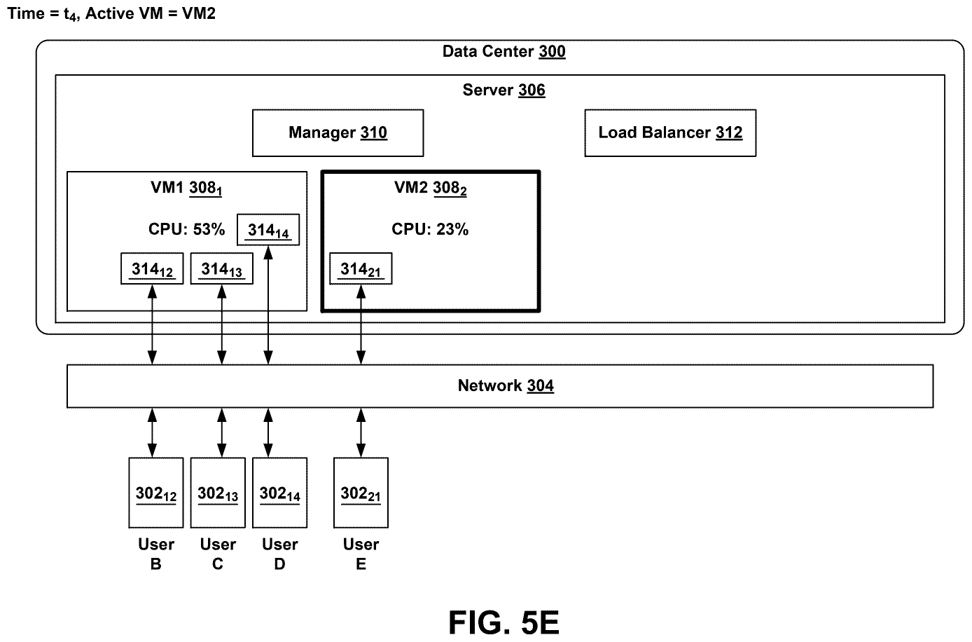

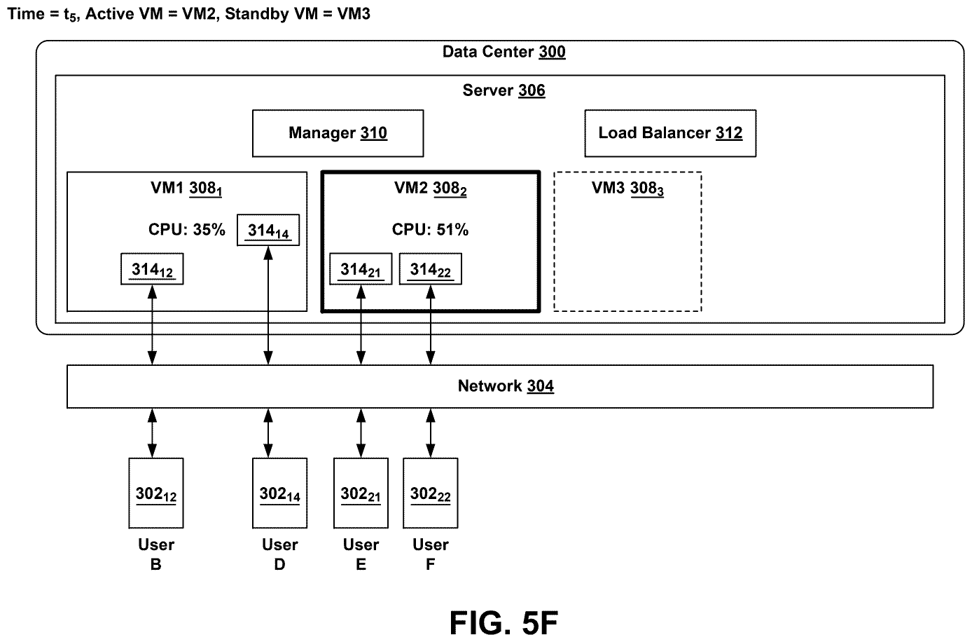

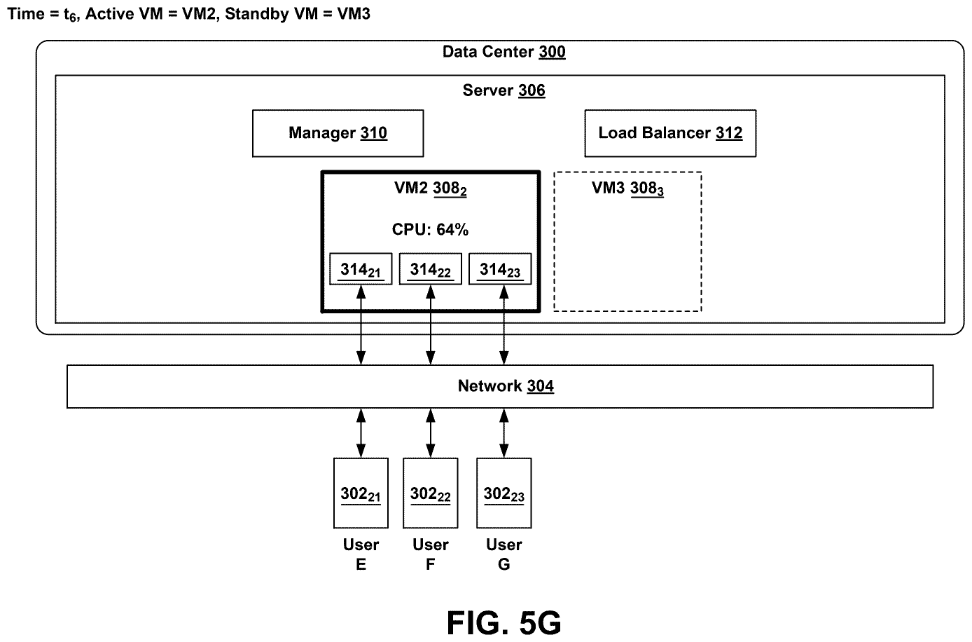

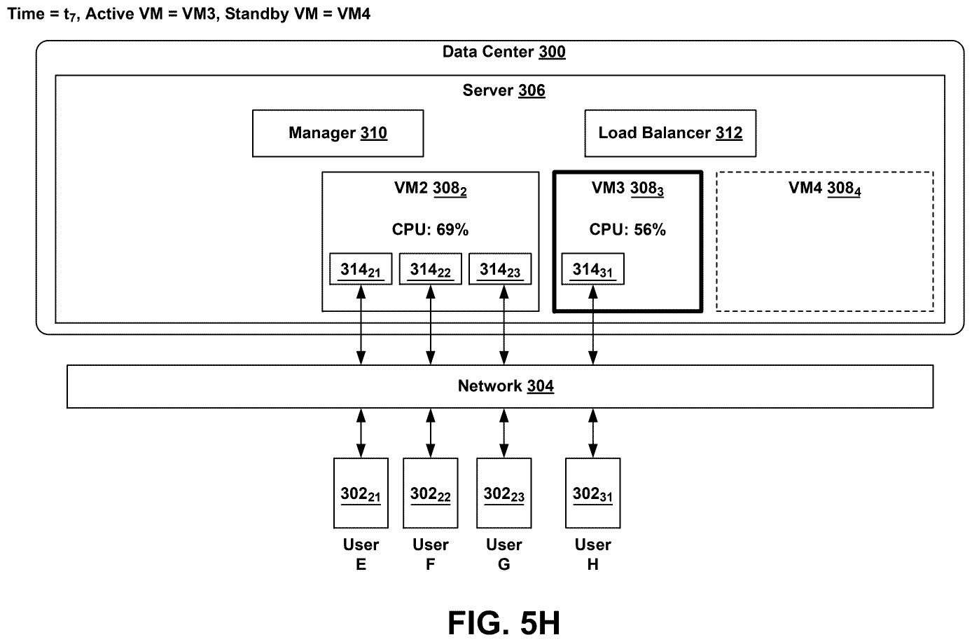

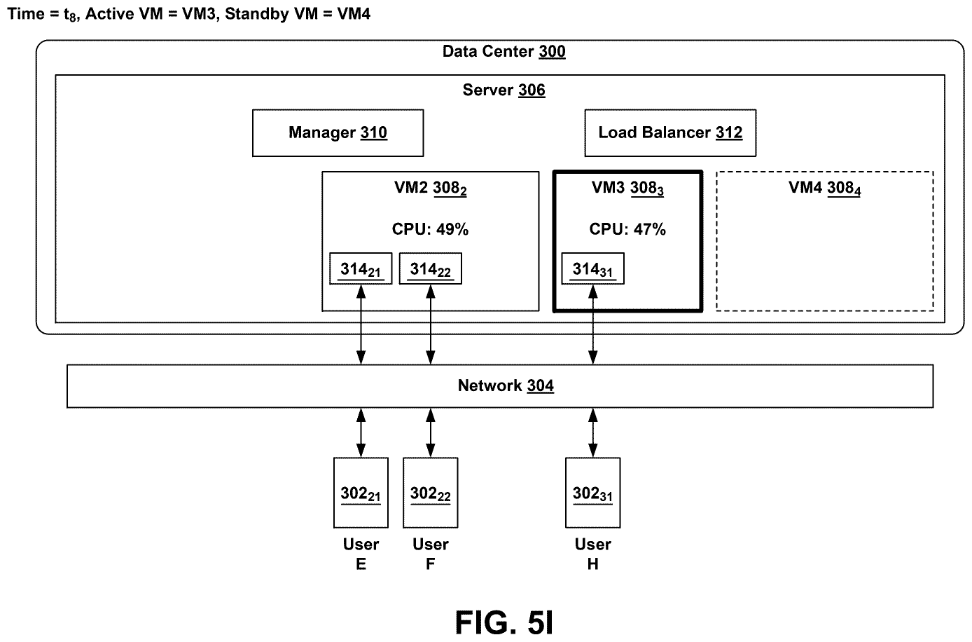

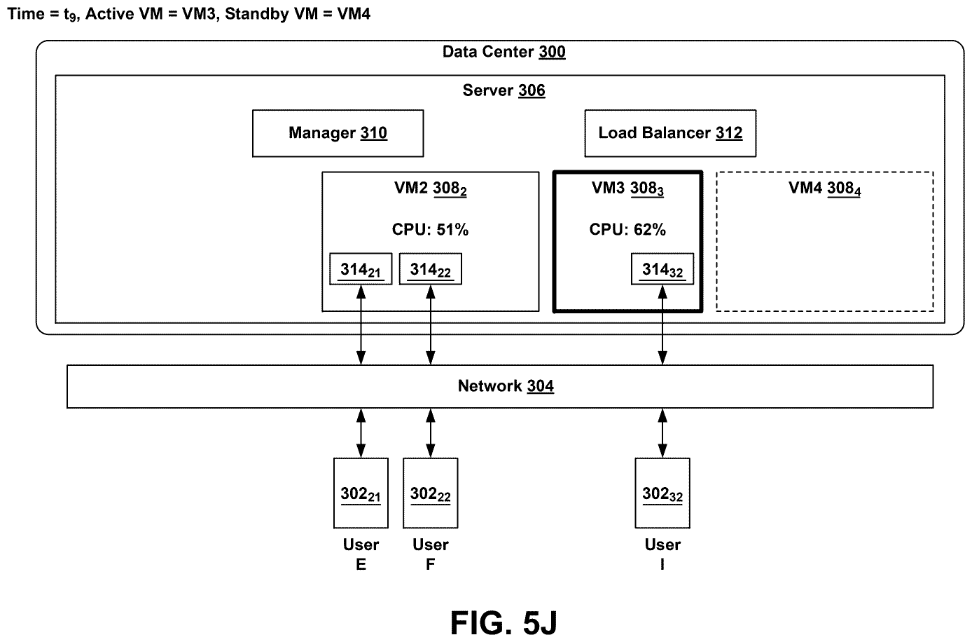

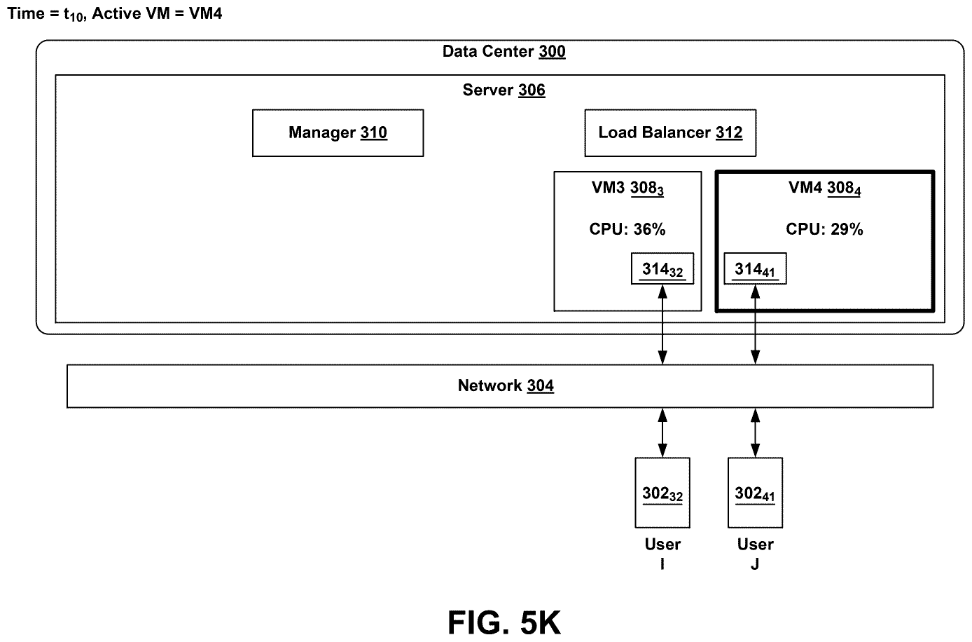

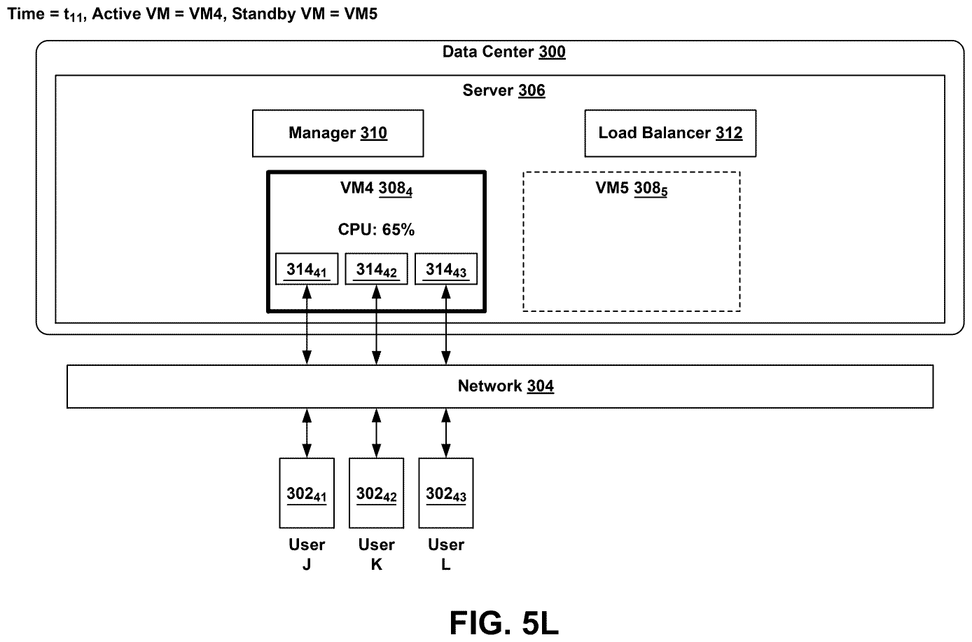

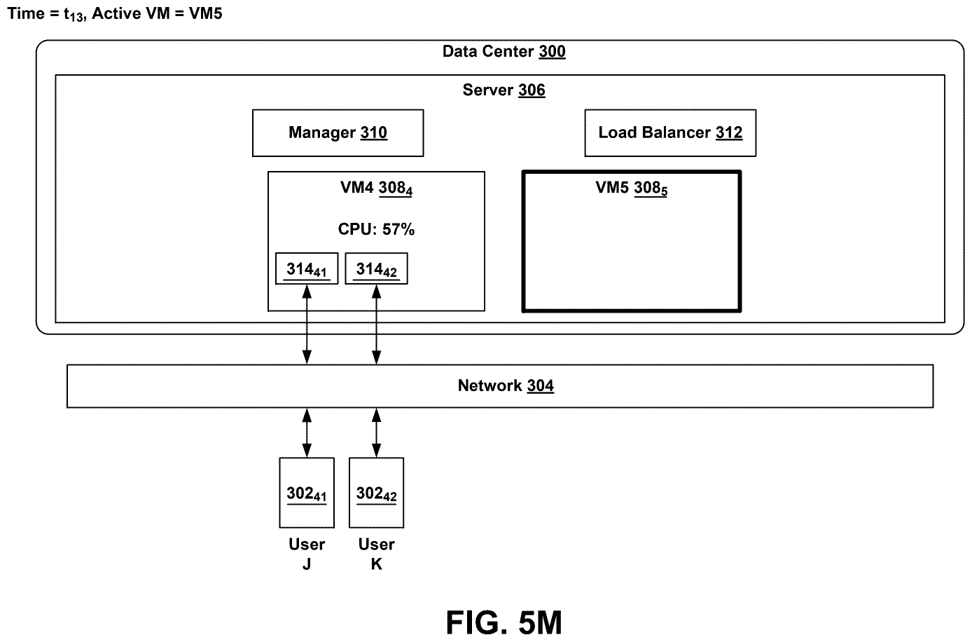

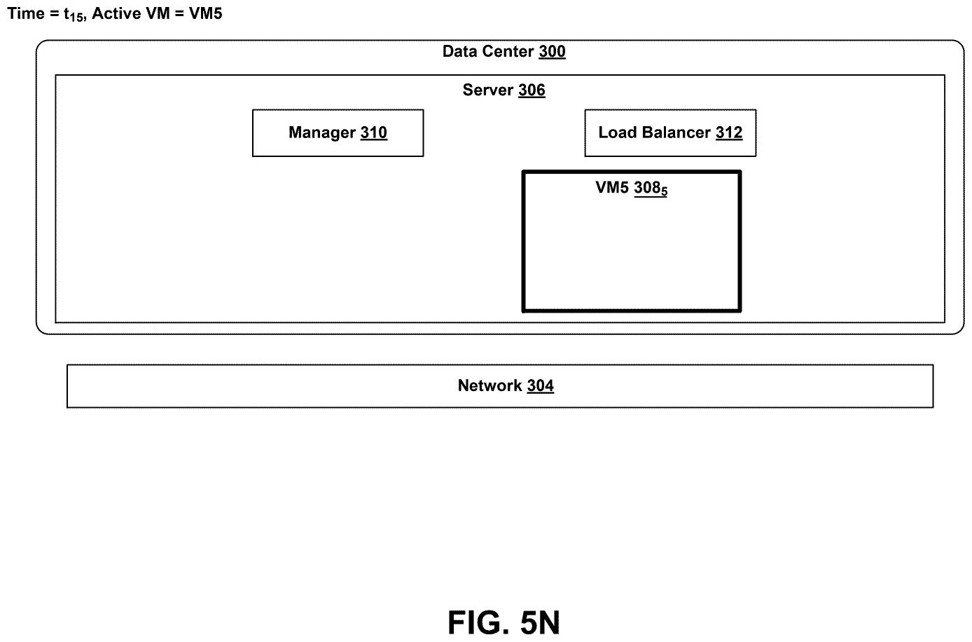

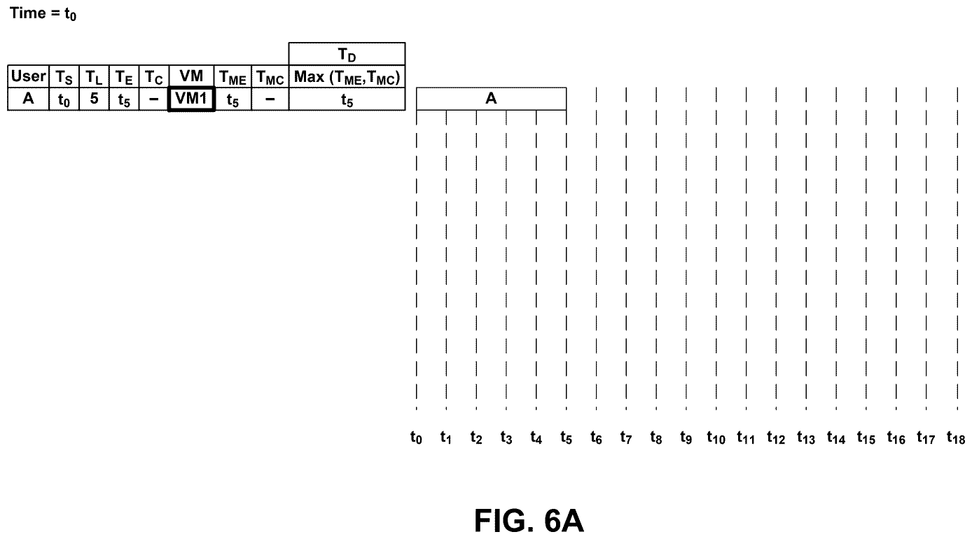

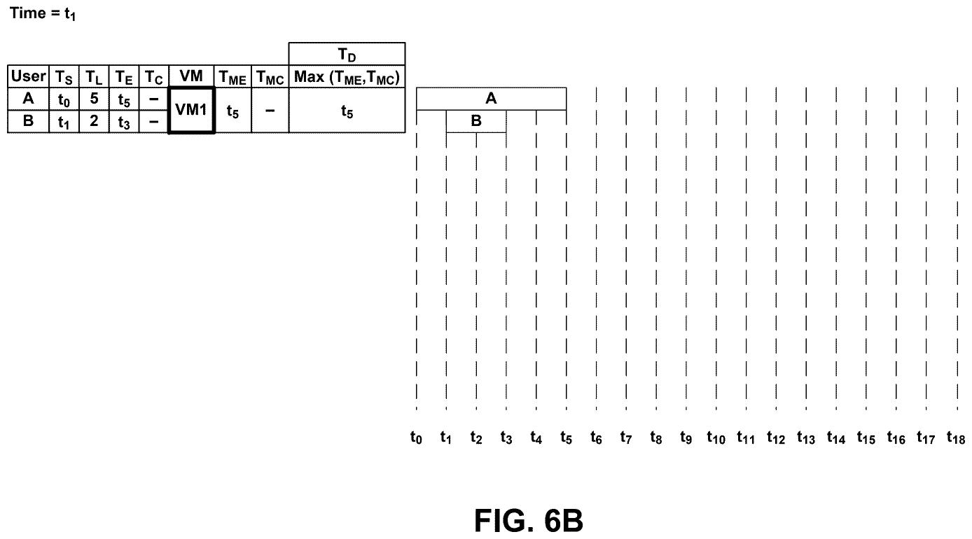

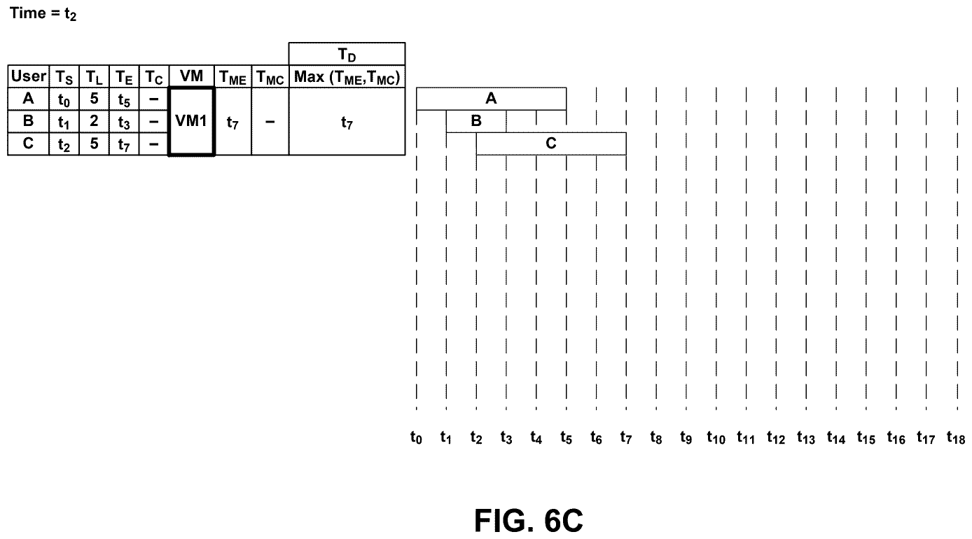

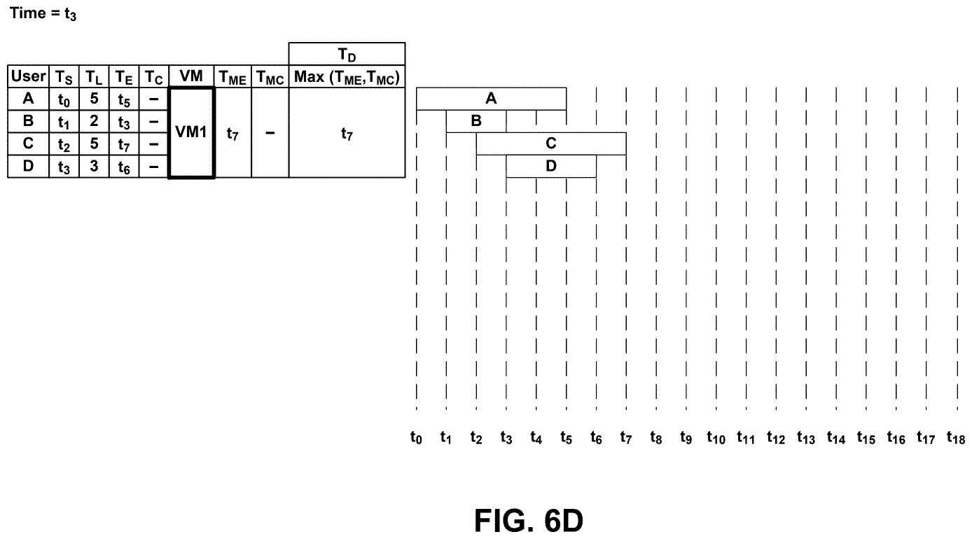

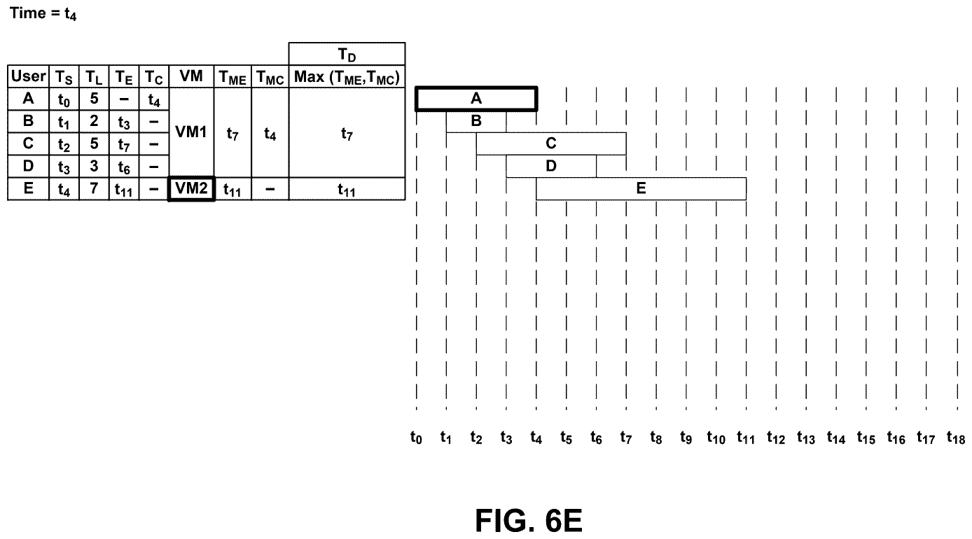

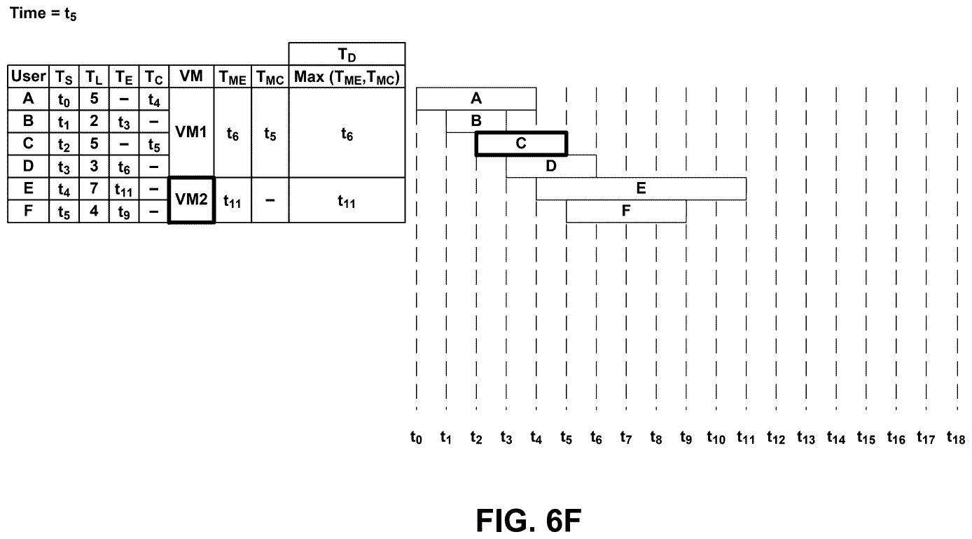

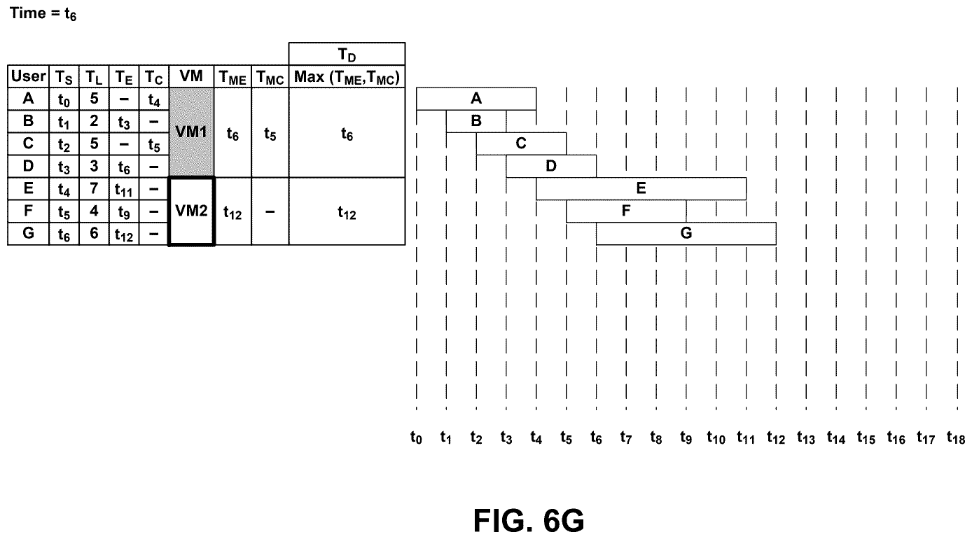

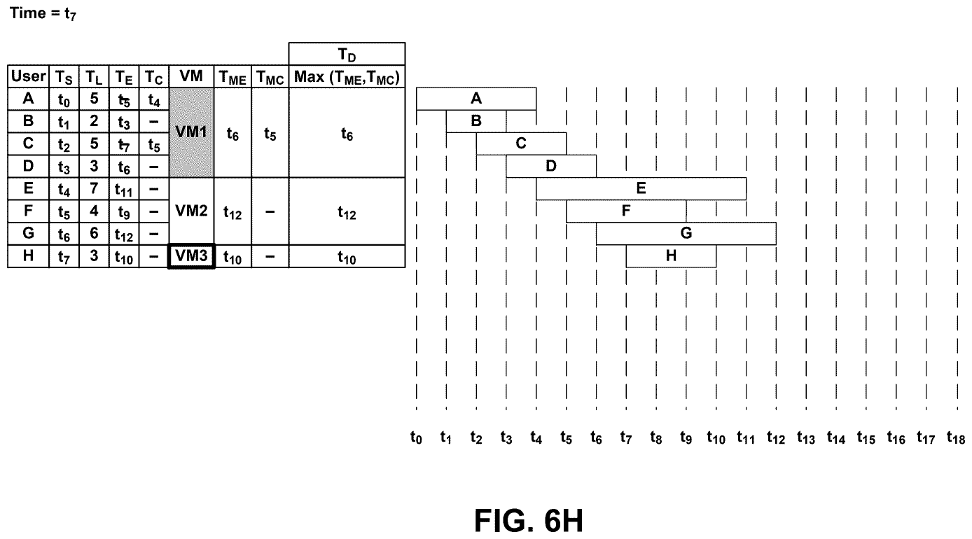

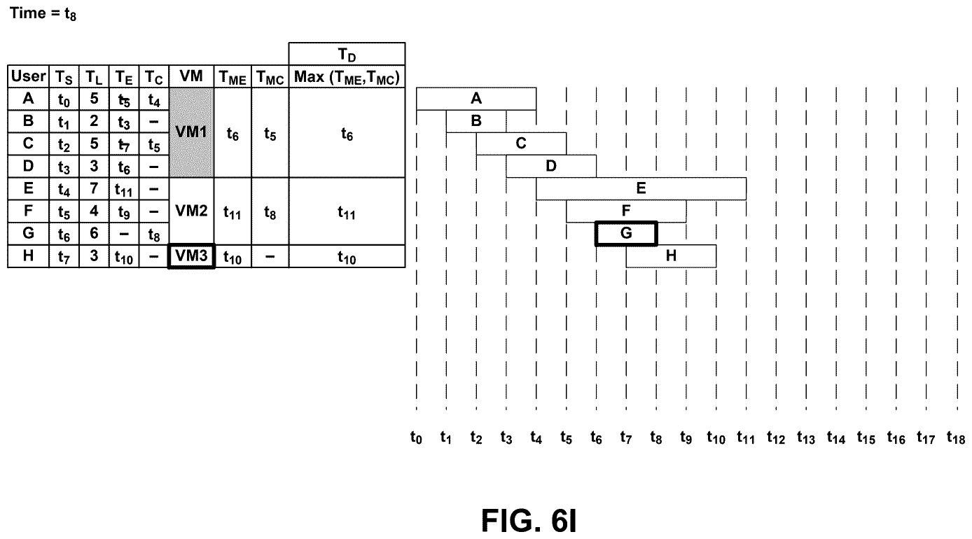

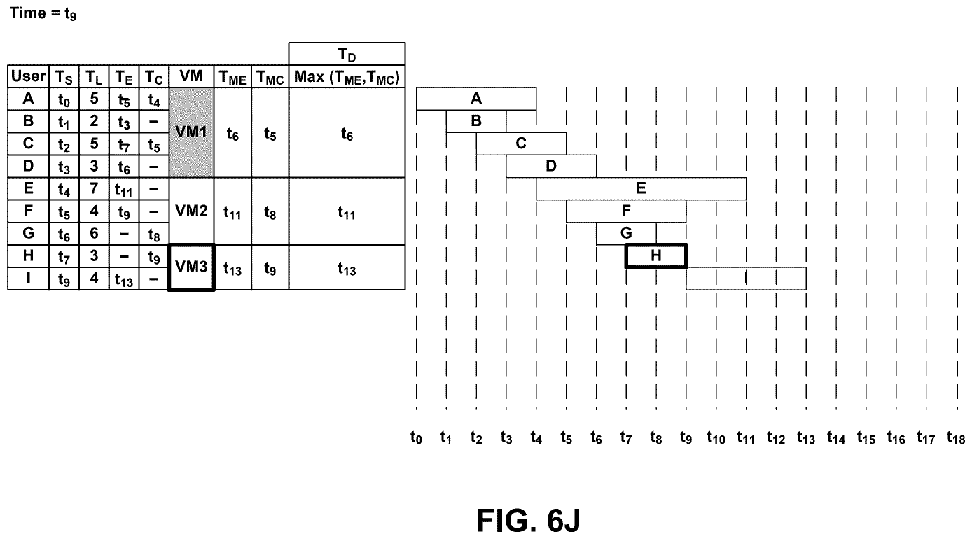

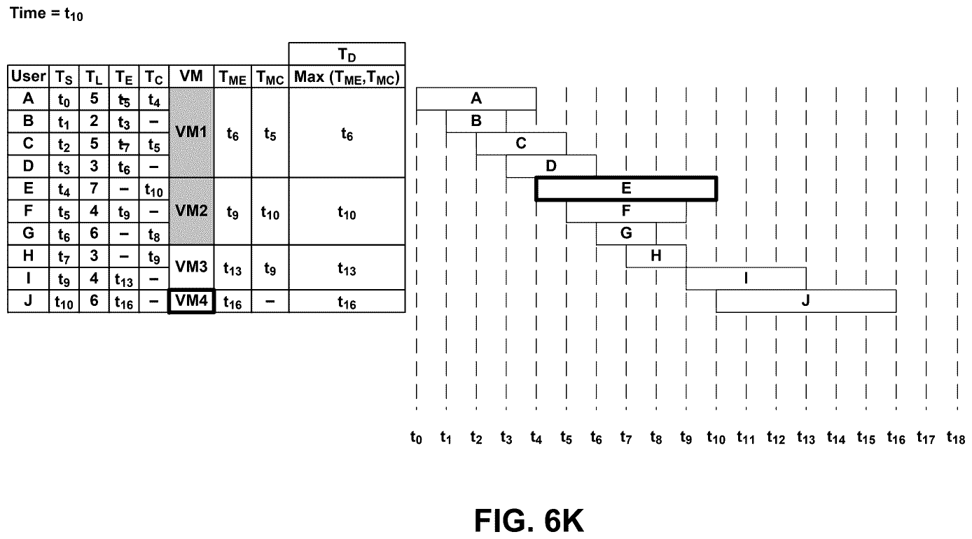

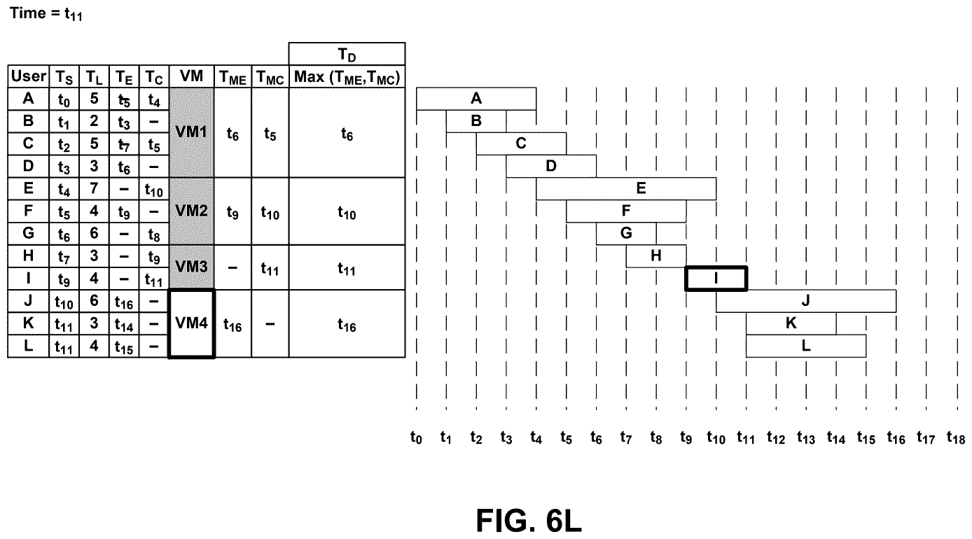

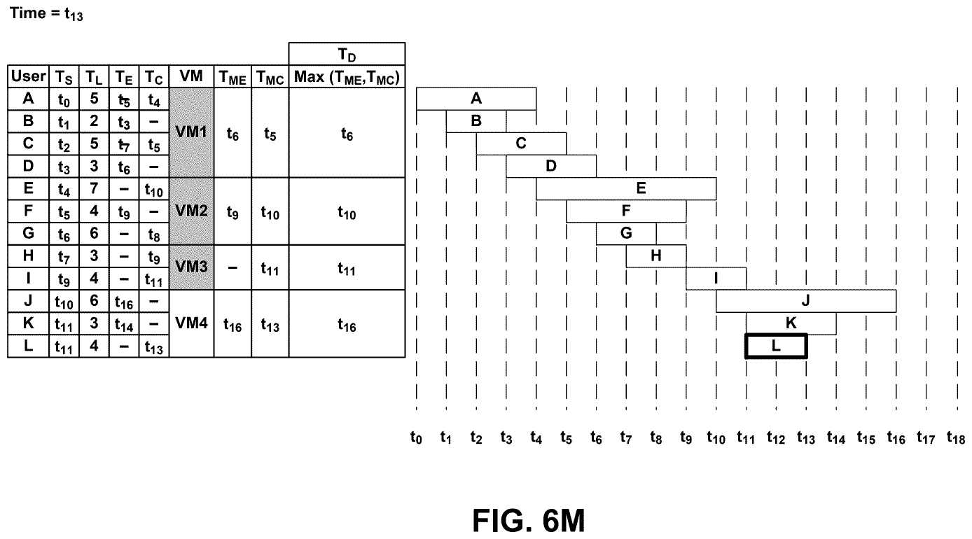

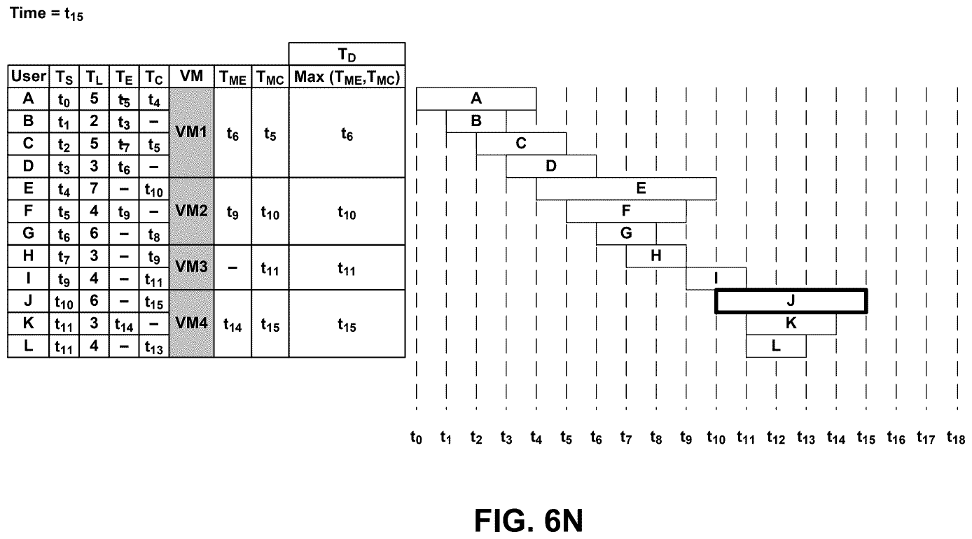

FIGS. 5A-5N illustrate an example computing environment performing an example implementation of operational procedures of FIGS. 4A-4C, and FIGS. 6A-6N depict corresponding timing diagrams for FIGS. 5A-5N, respectively. In the example embodiment of FIGS. 5A-5N and 6A-6N, each persistent session request has a corresponding desired persistent session duration T_{L}, and time is depicted in one unit increments. That is t₁−t₀=1 unit, t₂−t₁=1 unit, and so on. In addition, in this example machine readiness is characterized in terms of CPU utilization, with a first machine readiness threshold MR_{T1}=60%, and second machine readiness threshold MR_{T2}=50%. In addition, the example begins with virtual machine 308₁ (VM1) as the designated Active VM.

Referring to FIGS. 5A and 6A, at time t₀, in response to a persistent session request from User A on user computer 302₁₁, load balancer 312 routes the persistent session request to the Active VM (VM1). In response to the persistent session request, VM1 hosts persistent session 314₁₁ for User A.

In this example, the persistent session request specifies a desired persistent session duration T_{L}=5, and load balancer 312 determines a corresponding persistent session end time T_{E1}=t₀+5=t₅. Load balancer 312 also determines a corresponding maximum persistent session end time for VM1: T_{ME}=MAX(T_{E1})=t₅.

There are no cancelled sessions on VM1, and thus there is no maximum persistent session cancellation time T_{MC}. As a result, load balancer 312 determines a corresponding deallocation time for VM1: T_{D}=MAX(T_{ME}, T_{MC})=T_{ME}=t₅. CPU utilization on VM1 (35%) is less than first machine readiness threshold MR_{T1} (60%), and second machine readiness threshold MR_{T2} (50%).

Referring to FIGS. 5B and 6B, at time t₁, in response to a persistent session request from User B on user computer 302₁₂, load balancer 312 routes the persistent session request to the Active VM (VM1). In response to the persistent session request, VM1 hosts persistent session 314₁₂ for User B.

In this example, the persistent session request specifies a desired persistent session duration T_{L}=2, and load balancer 312 determines a corresponding persistent session end time T_{E2}=t₁+2=t₃. Load balancer 312 also determines a corresponding maximum persistent session end time for VM1: T_{ME}=MAX(T_{E1}, T_{E2})=t₅.

There are no cancelled sessions on VM1, and thus there is no maximum persistent session cancellation time T_{MC}. As a result, load balancer 312 determines a corresponding deallocation time for VM1: T_{D}=MAX(T_{ME}, T_{MC})=T_{ME}=t₅. CPU utilization on VM1 (47%) is less than first machine readiness threshold MR_{T1} (60%), and second machine readiness threshold MR_{T2} (50%).

Referring to FIGS. 5C and 6C, at time t₂, in response to a persistent session request from User C on user computer 302₁₃, load balancer 312 routes the persistent session request to the Active VM (VM1). In response to the persistent session request, VM1 hosts persistent session 314₁₃ for User C.

In this example, the persistent session request specifies a desired persistent session duration T_{L}=5, and load balancer 312 determines a corresponding persistent session end time T_{E3}=t₂+5=t₇. Load balancer 312 also determines a corresponding maximum persistent session end time for VM1: T_{ME}=MAX(T_{E1}, T_{E2}, T_{E3})=t₇.

There are no cancelled sessions on VM1, and thus there is no maximum persistent session cancellation time T_{MC}. As a result, load balancer 312 determines a corresponding deallocation time for VM1: T_{D}=MAX(T_{ME}, T_{MC})=T_{ME}=t₇. CPU utilization on VM1 (55%) is less than first machine readiness threshold MR_{T1} (60%), but greater than second machine readiness threshold MR_{T2} (50%). Because the CPU utilization of the Active VM (VM1) is greater than second machine readiness threshold MR_{T2} (50%), load balancer 312 launches virtual machine 308₂ (VM2) as a Standby VM.

Referring to FIGS. 5D and 6D, at time t₃, in response to a persistent session request from User D on user computer 302₁₄, load balancer 312 routes the persistent session request to the Active VM (VM1). In response to the persistent session request, VM1 hosts

### Persistent Session 314₁₄ for User D.

In this example, the persistent session request specifies a desired persistent session duration T_{L}=3, and load balancer 312 determines a corresponding persistent session end time T_{E4}=t₃+3=t₆. Load balancer 312 also determines a corresponding maximum persistent session end time for VM1: T_{ME}=MAX(T_{E1}, T_{E2}, T_{E3}, T_{E4})=t₇.

There are no cancelled sessions on VM1, and thus there is no maximum persistent session cancellation time T_{MC}. As a result, load balancer 312 determines a corresponding deallocation time for VM1: T_{D}=MAX(T_{ME}, T_{MC})=T_{ME}=t₇. CPU utilization on VM1 (68%) is greater than first machine readiness threshold MR_{T1} (60%). Because the CPU utilization of the Active VM (VM1) is greater than first machine readiness threshold MR_{T1} (60%), load balancer 312 de-designates VM1 as the Active VM, and designates the Standby VM (VM2) as the Active VM.

Referring to FIGS. 5E and 6E, at time t₄, in response to a persistent session request from User E on user computer 302₂₁, load balancer 312 routes the persistent session request to the Active VM (VM2). In response to the persistent session request, VM2 hosts persistent session 314₂₁ for User E.

In this example, the persistent session request specifies a desired persistent session duration T_{L}=7, and load balancer 312 determines a corresponding persistent session end time T_{E5}=t₄+7=t₁₁. Load balancer 312 also determines a corresponding maximum persistent session end time for VM2: T_{ME}=MAX(T_{E5})=t₁₁.

User A cancels persistent session 314₁₁ on VM1, and thus persistent session 314₁₁ has a corresponding persistent session cancellation time T_{C1}=t₄. Load balancer 312 determines a corresponding maximum persistent session cancellation time for VM1: T_{MC}=MAX(T_{C1})=t₄. As a result, load balancer 312 determines a corresponding deallocation time for VM1: T_{D}=MAX(T_{ME}, T_{MC})=T_{ME}=t₇. CPU utilization on VM2 (23%) is less than first machine readiness threshold MR_{T1} (60%), and less than second machine readiness threshold MR_{T2} (50%).

Referring to FIGS. 5F and 6F, at time t₅, in response to a persistent session request from User F on user computer 302₂₂, load balancer 312 routes the persistent session request to the Active VM (VM2). In response to the persistent session request, VM2 hosts persistent session 314₂₂ for User F.

In this example, the persistent session request specifies a desired persistent session duration T_{L}=4, and load balancer 312 determines a corresponding persistent session end time T_{E6}=t₅+4=t₉. Load balancer 312 also determines a corresponding maximum persistent session end time for VM1: T_{ME}=MAX(T_{E5}, T_{E6})=t₁₁.

User C cancels persistent session 314₁₃ on VM1, and thus persistent session 314₁₃ has a corresponding persistent session cancellation time T_{C3}=t₅. Load balancer 312 determines a corresponding maximum persistent session cancellation time for VM1: T_{MC}=MAX(T_{C1}, T_{C3})=t₅. As a result, load balancer 312 determines a corresponding deallocation time for VM1: T_{D}=MAX(T_{ME}, T_{MC})=T_{ME}=t₆. CPU utilization on VM2 (51%) is less than first machine readiness threshold MR_{T1} (60%), but greater than second machine readiness threshold MR_{T2} (50%). Because the CPU utilization of the Active VM (VM2) is greater than second machine readiness threshold MR_{T2} (50%), load balancer 312 launches virtual machine 308₃ (VM3) as a Standby VM.

Referring to FIGS. 5G and 6G, at time t₆, in response to a persistent session request from User G on user computer 302₂₃, load balancer 312 routes the persistent session request to the Active VM (VM2). In response to the persistent session request, VM2 hosts persistent session 314₂₃ for User G.

In this example, the persistent session request specifies a desired persistent session duration T_{L}=6, and load balancer 312 determines a corresponding persistent session end time T_{E7}=t₆+6=t₁₂. Load balancer 312 also determines a corresponding maximum persistent session end time for VM2: T_{ME}=MAX(T_{E5}, T_{E6}, T_{E7})=t₁₂.

There are no cancelled sessions on VM2, and thus there is no maximum persistent session cancellation time T_{MC}. As a result, load balancer 312 determines a corresponding deallocation time for VM2: T_{D}=MAX(T_{ME}, T_{MC})=T_{ME}=t₁₂. CPU utilization on VM2 (64%) is greater than first machine readiness threshold MR_{T1} (60%). Because the CPU utilization of the Active VM (VM2) is greater than first machine readiness threshold MR_{T1} (60%), load balancer 312 de-designates VM2 as the Active VM, and designates the Standby VM (VM3) as the Active VM.

Referring to FIGS. 5H and 6H, at time t₇, in response to a persistent session request from User H on user computer 302₃₁, load balancer 312 routes the persistent session request to the Active VM (VM3). In response to the persistent session request, VM3 hosts persistent session 314₃₁ for User H.

In this example, the persistent session request specifies a desired persistent session duration T_{L}=3, and load balancer 312 determines a corresponding persistent session end time T_{E8}=t₇+3=t₁₀. Load balancer 312 also determines a corresponding maximum persistent session end time for VM3: T_{ME}=MAX(T_{E8})=t₁₀.

There are no persistent session cancellations on VM3, and thus there is no maximum persistent session cancellation time T_{MC}. Load balancer 312 determines a corresponding maximum persistent session end time for VM3: T_{ME}=MAX(T_{E8})=t₁₀. As a result, load balancer 312 determines a corresponding deallocation time for VM3: T_{D}=MAX(T_{ME})=T_{ME}=t₁₀. CPU utilization on VM3 (56%) is less than first machine readiness threshold MR_{T1} (60%), but greater than second machine readiness threshold MR_{T2} (50%). Because the CPU utilization of the Active VM (VM3) is greater than second machine readiness threshold MR_{T2} (50%), load balancer 312 launches virtual machine 308₄ (VM4) as a Standby VM.

Referring to FIGS. 5I and 6I, at time t₈ User G cancels persistent session 314₂₃ on VM2, and thus persistent session 314₂₃ has a corresponding persistent session cancellation time T_{C7}=t₈. Load balancer 312 determines a corresponding maximum persistent session cancellation time for VM2: T_{MC}=MAX(T_{C7})=t₈. As a result, load balancer 312 determines a corresponding deallocation time for VM2: T_{D}=MAX(T_{ME}, T_{MC})=T_{ME}=t₁₁. CPU utilization on VM3 (47%) is less than first machine readiness threshold MR_{T1} (60%), and less than second machine readiness threshold MR_{T2} (50%).

Referring to FIGS. 5J and 6J, at time t₉, in response to a persistent session request from User I on user computer 302₃₂, load balancer 312 routes the persistent session request to the Active VM (VM3). In response to the persistent session request, VM3 hosts persistent session 314₃₂ for User I.

In this example, the persistent session request specifies a desired persistent session duration T_{L}=4, and load balancer 312 determines a corresponding persistent session end time T_{E9}=t₉+4=t₁₃. Load balancer 312 also determines a corresponding maximum persistent session end time for VM3: T_{ME}=MAX(T_{E8}, T_{E9})=t₁₃.

User H cancels persistent session 314₃₁ on VM3, and thus persistent session 314₃₁ has a corresponding persistent session cancellation time T_{C8}=t₉. Load balancer 312 determines a corresponding maximum persistent session cancellation time for VM3: T_{MC}=MAX(T_{C8})=t₉. As a result, load balancer 312 determines a corresponding deallocation time for VM3: T_{D}=MAX(T_{ME}, T_{MC})=T_{ME}=t₁₃. CPU utilization on VM3 (62%) is greater than first machine readiness threshold MR_{T1} (60. Because the CPU utilization of the Active VM (VM3) is greater than first machine readiness threshold MR_{T1} (60%), load balancer 312 de-designates VM3 as the Active VM, and designates the Standby VM (VM4) as the Active VM.

Referring to FIGS. 5K and 6K, at time t₁₀, in response to a persistent session request from User J on user computer 302₄₁, load balancer 312 routes the persistent session request to the Active VM (VM4). In response to the persistent session request, VM4 hosts persistent session 314₄₁ for User J.

In this example, the persistent session request specifies a desired persistent session duration T_{L}=6, and load balancer 312 determines a corresponding persistent session end time T_{E10}=t₁₀+6=t₁₆. Load balancer 312 also determines a corresponding maximum persistent session end time for VM4: T_{ME}=MAX(T_{E10})=t₁₆.

User E cancels persistent session 314₂₁ on VM2, and thus persistent session 314₂₁ has a corresponding persistent session cancellation time T_{C5}=t₁₀. Load balancer 312 determines a corresponding maximum persistent session cancellation time for VM2: T_{MC}=MAX(T_{C5}, T_{C7})=t₁₀. As a result, load balancer 312 determines a corresponding deallocation time for VM2: T_{D}=MAX(T_{ME}, T_{MC})=T_{MC}=t₁₀. Accordingly, load balancer 312 deallocates VM2.

CPU utilization on VM4 (29%) is less than first machine readiness threshold MR_{T1} (60%), and less than second machine readiness threshold MR_{T2} (50%).

Referring to FIGS. 5L and 6L, at time t₁₁, in response to a persistent session request from User K on user computer 302₄₂ and user L on user computer 302₄₃, load balancer 312 routes the persistent session requests to the Active VM (VM4). In response to the persistent session requests, VM4 hosts persistent session 314₄₂ for User K and persistent session 314₄₃ for User L.

In this example, the persistent session request for User K specifies a desired persistent session duration T_{L}=3, and load balancer 312 determines a corresponding persistent session end time T_{E11}=t₁₁+3=t₁₄. The persistent session request for User L specifies a desired persistent session duration T_{L}=4, and load balancer 312 determines a corresponding persistent session end time T_{E12}=t₁₁+4=t₁₅. Load balancer 312 also determines a corresponding maximum persistent session end time for VM4: T_{ME}=MAX(T_{E10}, T_{E11}, T_{E12})=t₁₆.

User I cancels persistent session 314₃₂ on VM3, and thus persistent session 314₃₂ has a corresponding persistent session cancellation time T_{C9}=t₁₁. Load balancer 312 determines a corresponding maximum persistent session cancellation time for VM3: T_{MC}=MAX(T_{C8}, T_{C9})=t₁₁. As a result, load balancer 312 determines a corresponding deallocation time for VM3: T_{D}=MAX(T_{MC})=T_{MC}=t₁₁. Accordingly, load balancer 312 deallocates VM3.

CPU utilization on VM4 (65%) is greater than first machine readiness threshold MR_{T1} (60%), and greater than second machine readiness threshold MR_{T2} (50%). Because the CPU utilization of the Active VM (VM4) is greater than second machine readiness threshold MR_{T2} (50%), load balancer 312 launches virtual machine 308₅ (VM5) as a Standby VM. In addition, because the CPU utilization of the Active VM (VM4) is greater than first machine readiness threshold MR_{T1} (60%), load balancer 312 de-designates VM4 as the Active VM, and designates the Standby VM (VM5) as the Active VM.

Referring to FIGS. 5M and 6M, at time t₁₃ User L cancels persistent session 314₄₃ on VM4, and thus persistent session 314₄₃ has a corresponding persistent session cancellation time T_{C12}=t₁₃. Load balancer 312 determines a corresponding maximum persistent session cancellation time for VM4: T_{MC}=MAX(T_{C12})=t₁₃. As a result, load balancer 312 determines a corresponding deallocation time for VM4: T_{D}=MAX(T_{ME}, T_{MC})=T_{ME}=t₁₆.

Referring to FIGS. 5N and 6N, at time t₁₅ User J cancels persistent session 314₄₁ on VM4, and thus persistent session 314₄₁ has a corresponding persistent session cancellation time T_{C10}=t₁₅. Load balancer 312 determines a corresponding maximum persistent session cancellation time for VM4: T_{MC}=MAX(T_{C10})=t₁₅. As a result, load balancer 312 determines a corresponding deallocation time for VM4: T_{D}=MAX(T_{ME}, T_{MC})=T_{MC}=t₁₅. Accordingly, load balancer 312 deallocates VM4.

As described above, in embodiments load balancer 312 routes received persistent session requests to virtual machines 308 based on machine readiness (e.g., CPU utilization, number of hosted persistent sessions, or some other parameter) of the virtual machines 308. In embodiments, a virtual machine 308 may have a machine readiness status having either of a first machine readiness value (e.g., “ready,” “1,” or some other value), or a second machine readiness value (e.g., “not ready,” “0,” or some other value). In other embodiments, a virtual machine 308 may have a machine readiness status also having a third machine readiness value (e.g., “launch backup,” “2,” or some other value).

In an embodiment, load balancer 312 determines a machine readiness status of a virtual machine 308 by comparing a monitored machine readiness parameter of the virtual machine 308 (e.g., CPU utilization) with a first machine readiness threshold MR_{T1} (e.g., 60%). In an embodiment, load balancer 312 determines that the machine readiness status of the virtual machine 308 has the first machine readiness value (e.g., ready) when the monitored machine readiness parameter of the virtual machine (e.g., CPU utilization) is less than or equal to the first machine readiness threshold MR_{T1} (e.g., 60%). In an embodiment, load balancer 312 determines that the machine readiness status of the virtual machine 308 has the second machine readiness value (e.g., not ready) when the monitored machine readiness parameter of the virtual machine 308 (e.g., CPU utilization) is less than or equal to the first machine readiness threshold MR_{T1} (e.g., 60%).

In an embodiment, load balancer 312 determines a machine readiness status of a virtual machine 308 by comparing a monitored machine readiness parameter of the virtual machine 308 (e.g., CPU utilization) with a second machine readiness threshold MR_{T2} (e.g., 50%). In embodiments, load balancer 312 determines that the machine readiness status of the virtual machine 308 has the third machine readiness value (e.g., launch backup) when the monitored machine readiness parameter of the virtual machine (e.g., CPU utilization) is greater than second machine readiness threshold MR_{T2} (e.g., 50%).

In other embodiments, each virtual machine 308 may determine a machine readiness status and may provide the machine readiness status to load balancer 312. For example, a virtual machine 308 may compare a machine readiness parameter of the virtual machine 308 (e.g., CPU utilization) with a first machine readiness threshold MR_{T1} (e.g., 60%). In an embodiment, virtual machine 308 determines that the machine readiness status of the virtual machine 308 has the first machine readiness value (e.g., ready) when the monitored machine readiness parameter of the virtual machine (e.g., CPU utilization) is less than or equal to the first machine readiness threshold MR_{T1} (e.g., 60%). In an embodiment, virtual machine 308 determines that the machine readiness status of the virtual machine 308 has the second machine readiness value (e.g., not ready) when the monitored machine readiness parameter of the virtual machine 308 (e.g., CPU utilization) is less than or equal to the first machine readiness threshold MR_{T1} (e.g., 60%).

In an embodiment, virtual machine 308 determines a machine readiness status of the virtual machine 308 by comparing a monitored machine readiness parameter of the virtual machine 308 (e.g., CPU utilization) with a second machine readiness threshold MR_{T2} (e.g., 50%). In embodiments, virtual machine 308 determines that the machine readiness status of the virtual machine 308 has the third machine readiness value (e.g., launch backup) when the monitored machine readiness parameter of the virtual machine (e.g., CPU utilization) is greater than second machine readiness threshold MR_{T2} (e.g., 50%).

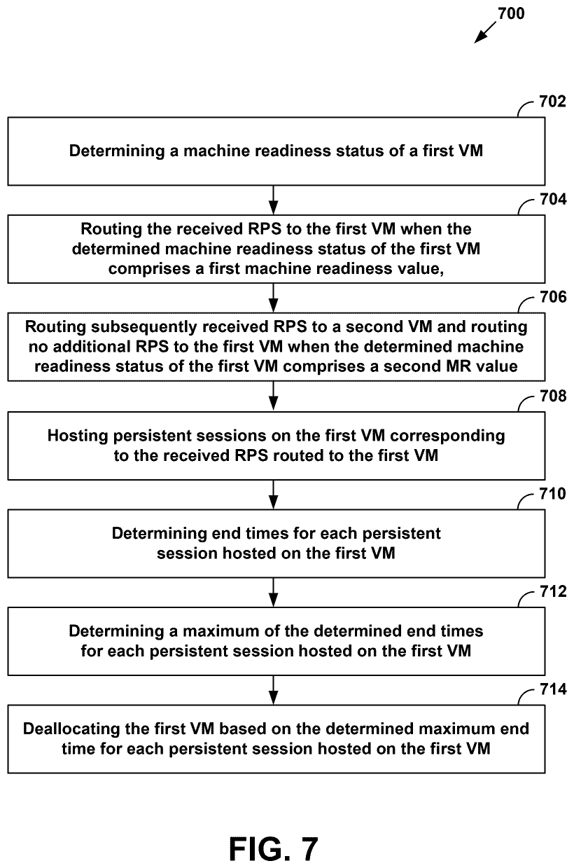

FIG. 7 illustrates an example operational procedure 700 for dynamically distributing persistent session requests to virtual machines and deallocating the virtual machines in accordance with the present disclosure. In embodiments, operational procedure 700 may be implemented in a system including one or more computing devices. For example, load balancer 312 of FIG. 3B may implement some or all of operational procedure 700.

Operation 702 illustrates determining a machine readiness status of a first virtual machine in the virtualized computing environment.

Operation 704 may follow operation 702. Operation 704 illustrates routing the received requests for persistent sessions to the first virtual machine when the determined machine readiness status of the first virtual machine comprises a first machine readiness value.

Operation 706 may follow operation 704. Operation 706 illustrates routing subsequently received requests for persistent sessions to a second virtual machine in the virtualized computing environment, and routing no additional received requests for persistent sessions to the first virtual machine when the determined machine readiness status of the first virtual machine comprises a second machine readiness value.

Operation 708 may follow operation 706. Operation 708 illustrates hosting persistent sessions on the first virtual machine corresponding to the received requests for persistent sessions routed to the first virtual machine.

Operation 710 may follow operation 708. Operation 710 illustrates determining end times for each persistent session hosted on the first virtual machine.

Operation 712 may follow operation 710. Operation 712 illustrates determining a maximum of the determined end times for each persistent session hosted on the first virtual machine.

Operation 714 may follow operation 712. Operation 714 illustrates deallocating the first virtual machine based on the determined maximum of the determined end times for each persistent session hosted on the first virtual machine.

The various aspects of the disclosure are described herein with regard to certain examples and embodiments, which are intended to illustrate but not to limit the disclosure. The subject matter presented herein may be implemented as a computer process, a computer-controlled apparatus, or a computing system or an article of manufacture, such as a computer-readable storage medium.

Although the subject matter described herein is presented in the general context of program modules that execute on one or more computing devices, other implementations may be performed in combination with other types of program modules. Generally, program modules include routines, programs, components, data structures and other types of structures that perform particular tasks or implement particular abstract data types.

The subject matter described herein may be practiced on or in conjunction with other computer system configurations beyond those described herein, including multiprocessor systems. The embodiments described herein also may be practiced in distributed computing environments, where tasks are performed by remote processing devices that are linked through a communications network. In a distributed computing environment, program modules may be located in both local and remote memory storage devices.

Networks established by or on behalf of a user to provide one or more services (such as various types of cloud-based computing or storage) accessible via the Internet and/or other networks to a distributed set of clients may be referred to as a service provider. Such a network may include one or more data centers such as data center 100 of FIG. 1, which are configured to host physical and/or virtualized computer servers, storage devices, networking equipment and the like, that may be used to implement and distribute the infrastructure and services offered by the service provider.

In some embodiments, a server that implements a portion or all of one or more of the technologies described herein, including the techniques to implement the capturing of network traffic may include a general-purpose computer system that includes or is configured to access one or more computer-accessible media.

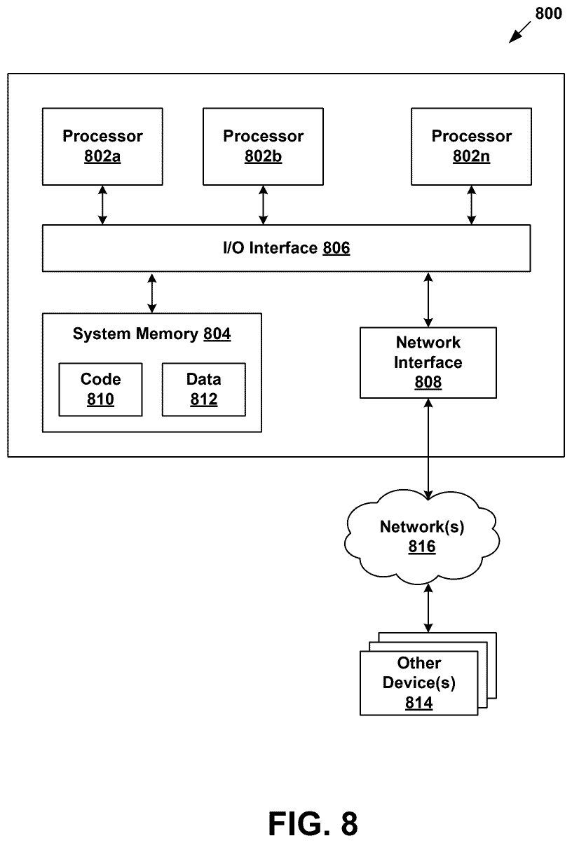

FIG. 8 illustrates such a general-purpose computing device 800. In the illustrated embodiment, computing device 800 includes one or more processors 802 (e.g., processors 802a, 802b, and/or 802n) coupled to a system memory 804 via an input/output (I/O) interface 806. Computing device 800 further includes a network interface 808 coupled to I/O interface 806.

In various embodiments, computing device 800 may be a uniprocessor system including one processor 802 or a multiprocessor system including several processors 802 (e.g., two, four, eight, or another suitable number). Processors 802 may be any suitable processors capable of executing instructions. For example, in various embodiments, processors 802 may be general-purpose or embedded processors implementing any of a variety of instruction set architectures (ISAs), such as the x96, PowerPC, SPARC, or MIPS ISAs, or any other suitable ISA. In multiprocessor systems, each of processors 802 may commonly, but not necessarily, implement the same ISA.

System memory 804 may be configured to store instructions and data accessible by processors 802. In various embodiments, system memory 804 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 804 as code 810 and data 812.

In one embodiment, I/O interface 806 may be configured to coordinate I/O traffic between processors 802, system memory 804, and any peripheral devices in the device, including network interface 808 or other peripheral interfaces. In some embodiments, I/O interface 806 may perform any necessary protocol, timing, or other data transformations to convert data signals from one component (e.g., system memory 804) into a format suitable for use by another component (e.g., processor 802).

In some embodiments, I/O interface 806 may include support for devices attached through various types of peripheral buses, such as a variant of the Peripheral Component Interconnect (PCI) bus standard or the Universal Serial Bus (USB) standard, for example. In some embodiments, the function of I/O interface 806 may be split into two or more separate components. Also, in some embodiments some or all of the functionality of I/O interface 806, such as an interface to system memory 804, may be incorporated directly into processor 802.

Network interface 808 may be configured to allow data to be exchanged between computing device 800 and other devices 814 attached to a network or network(s) 816, such as other computer systems or devices as illustrated in FIGS. 1-3B and FIGS. 5A-5N, for example.

In various embodiments, network interface 808 may support communication via any suitable wired or wireless general data networks, such as types of Ethernet networks, for example. Additionally, network interface 808 may support communication via telecommunications/telephony networks such as analog voice networks or digital fiber communications networks, via storage area networks such as Fibre Channel SANs or via any other suitable type of network and/or protocol.

In some embodiments, system memory 804 may be one embodiment of a computer-accessible medium configured to store program instructions and data as described above for FIGS. 1-6N for implementing embodiments of the corresponding methods and apparatus. However, in other embodiments, program instructions and/or data may be received, sent or stored upon different types of computer-accessible media.

A computer-accessible medium may include non-transitory storage media or memory media, such as magnetic or optical media, e.g., disk or DVD/CD coupled to computing device 800 via I/O interface 806. A non-transitory computer-accessible storage medium also may include any volatile or non-volatile media, such as RAM (e.g. SDRAM, DDR SDRAM, RDRAM, SRAM, etc.), ROM, etc., that may be included in some embodiments of computing device 800 as system memory 804 or another type of memory.

Further, a computer-accessible medium may include transmission media or signals such as electrical, electromagnetic or digital signals, conveyed via a communication medium such as a network and/or a wireless link, such as may be implemented via network interface 808.

Portions or all of multiple computing devices, such as those illustrated in FIG. 8, may be used to implement the described functionality in various embodiments. For example, software components running on a variety of different devices and servers may collaborate to provide the functionality.

In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. Computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data.

For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein.

For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like.

For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein.

These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, many types of physical transformations take place in the disclosed computing devices to store and execute the software components and/or functionality presented herein. The disclosed computing devices may not include all of the illustrated components shown in FIG. 7, may include other components that are not explicitly shown in FIG. 7, or may utilize an architecture completely different than that shown in FIG. 7.

The disclosure presented herein also encompasses the subject matter set forth in the following clauses:

Clause 1: A method for dynamically distributing received requests for persistent sessions hosted by computing systems of a virtualized computing environment, the method comprising: determining a machine readiness status of a first virtual machine in the virtualized computing environment; when the determined machine readiness status of the first virtual machine comprises a first machine readiness value, routing the received requests for persistent sessions to the first virtual machine; when the determined machine readiness status of the first virtual machine comprises a second machine readiness value, routing subsequently received requests for persistent sessions to a second virtual machine in the virtualized computing environment, and routing no additional received requests for persistent sessions to the first virtual machine; hosting persistent sessions on the first virtual machine corresponding to the received requests for persistent sessions routed to the first virtual machine; determining end times for each persistent session hosted on the first virtual machine; determining a maximum of the determined end times for each persistent session hosted on the first virtual machine; and deallocating the first virtual machine based on the determined maximum of the determined end times for each persistent session hosted on the first virtual machine.

Clause 2: The method of clause 1, further comprising launching the second virtual machine when the determined machine readiness status of the first virtual machine comprises a third machine readiness value.

Clause 3: The method of any of clauses 1-2, wherein determining the machine readiness status of the first virtual machine comprises: monitoring a machine readiness parameter of the first virtual machine; determining that the machine readiness status of the first virtual machine comprises the first machine readiness value when the monitored machine readiness parameter is less than or equal to a first machine readiness threshold; and determining that the machine readiness status of the first virtual machine comprises the second machine readiness value when the monitored machine readiness parameter is greater than the first machine readiness threshold.

Clause 4: The method of any of clauses 1-3, wherein the machine readiness status of the first virtual machine is determined based on a CPU usage of the first virtual machine.

Clause 5: The method of any of clauses 1-3, wherein the machine readiness status of the first virtual machine is determined based on a number of persistent sessions hosted on the first virtual machine.

Clause 6: The method of any of clauses 1-5, wherein determining the machine readiness status of the first virtual machine comprises receiving the machine readiness status from the first virtual machine.

Clause 7: The method of any of clauses 1-6, further comprising: receiving with each received request for a persistent session a corresponding desired persistent session duration; determining a corresponding start time for each persistent session hosted on the first virtual machine; and determining the corresponding end time for each persistent session hosted on the first virtual machine comprises determining a sum of the corresponding desired persistent session duration and the corresponding start time and for each persistent session hosted on the first virtual machine.

Clause 8: The method of any of clauses 1-6, further comprising: determining a corresponding start time for each persistent session hosted on the first virtual machine; and determining the corresponding end time for each persistent session hosted on the first virtual machine comprises determining a sum of a default persistent session duration and the corresponding start time and for each persistent session hosted on the first virtual machine.

Clause 9: A system comprising: one or more processors; and a memory in communication with the one or more processors, the memory having computer-readable instructions stored thereupon that, when executed by the one or more processors, cause the system to perform operations comprising: monitoring a machine readiness parameter of a first virtual machine in a virtualized computing environment; receiving requests for persistent sessions hosted by computing systems of the virtualized computing environment; routing received requests for persistent sessions to the first virtual machine when the monitored machine readiness parameter of the first virtual machine is less than or equal to a first machine readiness threshold; routing subsequently received requests for persistent sessions to a second virtual machine in the virtualized computing environment when the monitored machine readiness parameter of the first virtual machine is greater than the first machine readiness threshold, and routing no additional requests for persistent sessions to the first virtual machine; hosting persistent sessions on the first virtual machine corresponding to the received persistent session requests routed to the first virtual machine; determining an end time for each persistent session hosted on the first virtual machine; determining for the first virtual machine a maximum of the end times for each persistent session hosted on the first virtual machine; determining a cancellation time for each persistent session hosted on the first virtual machine; determining for the first virtual machine a maximum of the cancellation times for each persistent session hosted on the first virtual machine; and deallocating the first virtual machine based on the greater of the determined maximum of the determined end times and the determined maximum of the cancellation times for each persistent session hosted on the first virtual machine.

Clause 10: The system of clause 9, further comprising computer-readable instructions stored thereupon that, when executed by the one or more processors, cause the system to perform operations comprising: launching the second virtual machine when the monitored machine readiness parameter of the first virtual machine is greater than a second machine readiness threshold.

Clause 11: The system of any of clauses 9-10, further comprising computer-readable instructions stored thereupon that, when executed by the one or more processors, cause the system to perform operations comprising: monitoring a machine readiness parameter of the second virtual machine; routing received requests for persistent sessions to the second virtual machine when the monitored machine readiness parameter of the second virtual machine is less than or equal to the first machine readiness threshold; routing subsequently received requests for persistent sessions to a third virtual machine in the virtualized computing environment when the monitored machine readiness parameter of the second virtual machine is greater than the first machine readiness threshold, and routing no additional requests for persistent sessions to the second virtual machine; hosting persistent sessions on the second virtual machine corresponding to the received persistent session requests routed to the second virtual machine; determining an end time for each persistent session hosted on the second virtual machine; determining for the second virtual machine a maximum of the end times for each persistent session hosted on the second virtual machine; determining a cancellation time for each persistent session hosted on the second virtual machine; determining for the second virtual machine a maximum of the cancellation times for each persistent session hosted on the second virtual machine; and deallocating the second virtual machine based on the greater of the determined maximum of the determined end times and the determined maximum of the cancellation times for each persistent session hosted on the second virtual machine.

Clause 12: The system of any of clauses 9-11, further comprising computer-readable instructions stored thereupon that, when executed by the one or more processors, cause the system to perform operations comprising: monitoring a machine readiness parameter of the second virtual machine; and launching a third virtual machine in the virtualized computing environment when the monitored machine readiness parameter of the second virtual machine is greater than a second machine readiness threshold.

Clause 13: The system of any of clauses 9-12, wherein the machine readiness parameter comprises a CPU usage, and the first machine readiness threshold comprises a first CPU usage.

Clause 14: The system of any of clauses 9-12, wherein the machine readiness parameter comprises a number of hosted persistent sessions, and the first machine readiness threshold comprises a first number of hosted persistent sessions.

Clause 15: The system of any of clauses 9-14, further comprising computer-readable instructions stored thereupon that, when executed by the one or more processors, cause the system to perform operations comprising: receiving with each received request for a persistent session a corresponding desired persistent session duration; determining a corresponding start time for each persistent session hosted on the first virtual machine; and determining the corresponding end time for each persistent session hosted on the first virtual machine comprises determining a sum of the corresponding desired persistent session duration and the corresponding start time and for each persistent session hosted on the first virtual machine.

Clause 16: The system of any of clauses 9-14, further comprising computer-readable instructions stored thereupon that, when executed by the one or more processors, cause the system to perform operations comprising: determining a corresponding start time for each persistent session hosted on the first virtual machine; and determining the corresponding end time for each persistent session hosted on the first virtual machine comprises determining a sum of a default persistent session duration and the corresponding start time and for each persistent session hosted on the first virtual machine.

Clause 17: A computer-readable storage medium having computer-executable instructions stored thereupon which, when executed by one or more processors of a computing device, cause the computing device to perform operations comprising: monitoring a machine readiness parameter of a first virtual machine in a virtualized computing environment; receiving requests for persistent sessions hosted by computing systems of the virtualized computing environment; routing received requests for persistent sessions to the first virtual machine when the monitored machine readiness parameter of the first virtual machine is less than or equal to a first machine readiness threshold; routing subsequently received requests for persistent sessions to a second virtual machine in the virtualized computing environment when the monitored machine readiness parameter of the first virtual machine is greater than the first machine readiness threshold, and routing no additional requests for persistent sessions to the first virtual machine; hosting persistent sessions on the first virtual machine corresponding to the received persistent session requests routed to the first virtual machine; determining an end time for each persistent session hosted on the first virtual machine; determining for the first virtual machine a maximum of the end times for each persistent session hosted on the first virtual machine; and terminating the first virtual machine based on the determined maximum of the determined end times corresponding to each persistent session hosted on the first virtual machine.

Clause 18: The computer-readable storage medium of clause 17, further comprising computer-executable instructions stored thereupon which, when executed by one or more processors of a computing device, cause the computing device to perform operations comprising: launching the second virtual machine when the monitored machine readiness parameter of the first virtual machine is greater than a second machine readiness threshold.

Clause 19: The computer-readable storage medium of any of clauses 17-18, wherein the machine readiness parameter comprises a CPU usage, and the first machine readiness threshold comprises a first CPU usage.

Clause 20: The computer-readable storage medium of any of clauses 17-18, wherein the machine readiness parameter comprises a number of hosted persistent sessions, and the first machine readiness threshold comprises a first number of hosted persistent sessions.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps.

Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Although certain example embodiments have been described, these embodiments have been presented by way of example only, and are not intended to limit the scope of the technology disclosed herein. Thus, nothing in the foregoing description is intended to imply that any particular feature, characteristic, step, module, or block is necessary or indispensable.

The methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of certain of the technology disclosed herein.

Any reference to “first,” “second,” etc. items and/or abstract concepts within the description is not intended to and should not be construed to necessarily correspond to any reference of “first,” “second,” etc., elements of the claims. In particular, items and/or abstract concepts such as, for example, individual computing devices and/or operational states of the computing cluster may be distinguished by numerical designations without such designations corresponding to the claims or even other paragraphs of the Summary and/or Detailed Description.

For example, any designation of a “first operational state” and “second operational state” of the computing cluster within a paragraph of this disclosure is used solely to distinguish two different operational states of the computing cluster within that specific paragraph-not any other paragraph and particularly not the claims.

Although the various techniques have been described in language specific to structural features and/or methodological acts, the subject matter defined in the appended representations is not necessarily limited to the specific features or acts described. Rather, the specific features and acts are disclosed as example forms of implementing the claimed subject matter.

1. A method for dynamically distributing received requests for persistent sessions hosted by computing systems of a virtualized computing environment, the method comprising:
determining a machine readiness status of a first virtual machine in the virtualized computing environment;
when the determined machine readiness status of the first virtual machine comprises a first machine readiness value, routing the received requests for persistent sessions to the first virtual machine;
when the determined machine readiness status of the first virtual machine comprises a second machine readiness value, routing subsequently received requests for persistent sessions to a second virtual machine in the virtualized computing environment, and routing no additional received requests for persistent sessions to the first virtual machine;
hosting persistent sessions on the first virtual machine corresponding to the received requests for persistent sessions routed to the first virtual machine;
determining end times for each persistent session hosted on the first virtual machine;
determining a maximum of the determined end times for each persistent session hosted on the first virtual machine; and
deallocating the first virtual machine based on the determined maximum of the determined end times for each persistent session hosted on the first virtual machine.

2. The method of claim 1, further comprising launching the second virtual machine when the determined machine readiness status of the first virtual machine comprises a third machine readiness value.

3. The method of claim 1, wherein determining the machine readiness status of the first virtual machine comprises:
monitoring a machine readiness parameter of the first virtual machine;
determining that the machine readiness status of the first virtual machine comprises the first machine readiness value when the monitored machine readiness parameter is less than or equal to a first machine readiness threshold; and
determining that the machine readiness status of the first virtual machine comprises the second machine readiness value when the monitored machine readiness parameter is greater than the first machine readiness threshold.

4. The method of claim 1, wherein the machine readiness status of the first virtual machine is determined based on a CPU usage of the first virtual machine.

5. The method of claim 1, wherein the machine readiness status of the first virtual machine is determined based on a number of persistent sessions hosted on the first virtual machine.

6. The method of claim 1, wherein determining the machine readiness status of the first virtual machine comprises receiving the machine readiness status from the first virtual machine.

7. The method of claim 1, further comprising:
receiving with each received request for a persistent session a corresponding desired persistent session duration;
determining a corresponding start time for each persistent session hosted on the first virtual machine; and
determining the corresponding end time for each persistent session hosted on the first virtual machine comprises determining a sum of the corresponding desired persistent session duration and the corresponding start time and for each persistent session hosted on the first virtual machine.

8. The method of claim 1, further comprising:
determining a corresponding start time for each persistent session hosted on the first virtual machine; and
determining the corresponding end time for each persistent session hosted on the first virtual machine comprises determining a sum of a default persistent session duration and the corresponding start time and for each persistent session hosted on the first virtual machine.

9. A system comprising:
one or more processors; and
a memory in communication with the one or more processors, the memory having computer-readable instructions stored thereupon that, when executed by the one or more processors, cause the system to perform operations comprising:
monitoring a machine readiness parameter of a first virtual machine in a virtualized computing environment;
receiving requests for persistent sessions hosted by computing systems of the virtualized computing environment;
routing received requests for persistent sessions to the first virtual machine when the monitored machine readiness parameter of the first virtual machine is less than or equal to a first machine readiness threshold;
routing subsequently received requests for persistent sessions to a second virtual machine in the virtualized computing environment when the monitored machine readiness parameter of the first virtual machine is greater than the first machine readiness threshold, and routing no additional requests for persistent sessions to the first virtual machine;
hosting persistent sessions on the first virtual machine corresponding to the received persistent session requests routed to the first virtual machine;
determining an end time for each persistent session hosted on the first virtual machine;
determining for the first virtual machine a maximum of the end times for each persistent session hosted on the first virtual machine;
determining a cancellation time for each persistent session hosted on the first virtual machine;
determining for the first virtual machine a maximum of the cancellation times for each persistent session hosted on the first virtual machine; and
deallocating the first virtual machine based on the greater of the determined maximum of the determined end times and the determined maximum of the cancellation times for each persistent session hosted on the first virtual machine.

10. The system of claim 9, further comprising computer-readable instructions stored thereupon that, when executed by the one or more processors, cause the system to perform operations comprising:
launching the second virtual machine when the monitored machine readiness parameter of the first virtual machine is greater than a second machine readiness threshold.

11. The system of claim 9, further comprising computer-readable instructions stored thereupon that, when executed by the one or more processors, cause the system to perform operations comprising:
monitoring a machine readiness parameter of the second virtual machine;
routing received requests for persistent sessions to the second virtual machine when the monitored machine readiness parameter of the second virtual machine is less than or equal to the first machine readiness threshold;
routing subsequently received requests for persistent sessions to a third virtual machine in the virtualized computing environment when the monitored machine readiness parameter of the second virtual machine is greater than the first machine readiness threshold, and routing no additional requests for persistent sessions to the second virtual machine;
hosting persistent sessions on the second virtual machine corresponding to the received persistent session requests routed to the second virtual machine;
determining an end time for each persistent session hosted on the second virtual machine;
determining for the second virtual machine a maximum of the end times for each persistent session hosted on the second virtual machine;
determining a cancellation time for each persistent session hosted on the second virtual machine;
determining for the second virtual machine a maximum of the cancellation times for each persistent session hosted on the second virtual machine; and
deallocating the second virtual machine based on the greater of the determined maximum of the determined end times and the determined maximum of the cancellation times for each persistent session hosted on the second virtual machine.

12. The system of claim 9, further comprising computer-readable instructions stored thereupon that, when executed by the one or more processors, cause the system to perform operations comprising:
monitoring a machine readiness parameter of the second virtual machine; and
launching a third virtual machine in the virtualized computing environment when the monitored machine readiness parameter of the second virtual machine is greater than a second machine readiness threshold.

13. The system of claim 9, wherein the machine readiness parameter comprises a CPU usage, and the first machine readiness threshold comprises a first CPU usage.

14. The system of claim 9, wherein the machine readiness parameter comprises a number of hosted persistent sessions, and the first machine readiness threshold comprises a first number of hosted persistent sessions.

15. The system of claim 9, further comprising computer-readable instructions stored thereupon that, when executed by the one or more processors, cause the system to perform operations comprising:
receiving with each received request for a persistent session a corresponding desired persistent session duration;
determining a corresponding start time for each persistent session hosted on the first virtual machine; and
determining the corresponding end time for each persistent session hosted on the first virtual machine comprises determining a sum of the corresponding desired persistent session duration and the corresponding start time and for each persistent session hosted on the first virtual machine.

16. The system of claim 9, further comprising computer-readable instructions stored thereupon that, when executed by the one or more processors, cause the system to perform operations comprising:
determining a corresponding start time for each persistent session hosted on the first virtual machine; and
determining the corresponding end time for each persistent session hosted on the first virtual machine comprises determining a sum of a default persistent session duration and the corresponding start time and for each persistent session hosted on the first virtual machine.

17. A computer-readable storage medium having computer-executable instructions stored thereupon which, when executed by one or more processors of a computing device, cause the computing device to perform operations comprising:
monitoring a machine readiness parameter of a first virtual machine in a virtualized computing environment;
receiving requests for persistent sessions hosted by computing systems of the virtualized computing environment;
routing received requests for persistent sessions to the first virtual machine when the monitored machine readiness parameter of the first virtual machine is less than or equal to a first machine readiness threshold;
routing subsequently received requests for persistent sessions to a second virtual machine in the virtualized computing environment when the monitored machine readiness parameter of the first virtual machine is greater than the first machine readiness threshold, and routing no additional requests for persistent sessions to the first virtual machine;
hosting persistent sessions on the first virtual machine corresponding to the received persistent session requests routed to the first virtual machine;
determining an end time for each persistent session hosted on the first virtual machine;
determining for the first virtual machine a maximum of the end times for each persistent session hosted on the first virtual machine; and
terminating the first virtual machine based on the determined maximum of the determined end times corresponding to each persistent session hosted on the first virtual machine.

18. The computer-readable storage medium of claim 17, further comprising computer-executable instructions stored thereupon which, when executed by one or more processors of a computing device, cause the computing device to perform operations comprising:
launching the second virtual machine when the monitored machine readiness parameter of the first virtual machine is greater than a second machine readiness threshold.

19. The computer-readable storage medium of claim 17, wherein the machine readiness parameter comprises a CPU usage, and the first machine readiness threshold comprises a first CPU usage.

20. The computer-readable storage medium of claim 17, wherein the machine readiness parameter comprises a number of hosted persistent sessions, and the first machine readiness threshold comprises a first number of hosted persistent sessions.
